(19) United States
(12) Patent Application Publication
(10) Pub. No.: US 2004/0174326 A1
(43) Pub. Date: Sep. 9, 2004

(54) Illumination service providing method, illumination apparatus, recording medium, and reproduction apparartus

(76) Inventors: Shinichi Yamamoto, Hirakata (JP); Koji Honda, Hirakata (JP)

Correspondence Address: SNELL & WILMER, ONE ARIZONA CENTER, 400 EAST VAN BUREN, PHOENIX, AZ, 850040001

(21) Appl. No.: 10/482,368

(22) PCT Filed: Jun. 28, 2002
(86) PCT No.: PCT/JP02/06623

(30) Foreign Application Priority Data
Jun. 28, 2001 (JP) 2001-197552

(51) Int. Cl. G09G 3/32

(52) U.S. Cl. 345/82

(57) ABSTRACT

An illumination service providing method capable of realizing an entertainment feature. By using an illumination apparatus (10) having a plurality of pixels (16), each of which can be controlled independently, and a computer (1), an illumination service is provided for illuminating a predetermined space in a desired form. This method includes a step ST1 where the computer (1) receives an illumination service order (121), steps ST3 and ST5 where the computer (1) acquires illumination control data (131) for controlling the plurality of pixels (16) contained in the illumination apparatus (10) according to the illumination service order (121), and a step ST4 where the computer (1) provides the illumination control data (131).

### TECHNICAL FIELD

The present invention relates to a method for providing an illumination service using a computer system, an illumination apparatus, a recording medium and a reproduction apparatus.

### BACKGROUND ART

Conventionally, an illumination apparatus has been designed for the purpose of increasing the brightness of light emitted by the illumination apparatus and the average color rendering evaluation index (Ra) of light emitted by the illumination apparatus. The average color rendering evaluation index is one of indices which represent the fidelity at which a color of an object is seen under the light emitted by an illumination apparatus.

For an illumination apparatus based on the above-described designing concept, it is desired that the brightness and the average color rendering evaluation index diverge from the designed value as little as possible while the illumination apparatus is lit. Accordingly, the form of illumination is fixed for conventional illumination apparatuses. Such an illumination apparatus cannot illuminate a space with a form desired by the user, and thus could not provide any entertaining factor.

Conventionally, no illumination service has been proposed to control an illumination apparatus such that the illumination apparatus provide an entertaining factor.

The present invention, made in light of the above-described problems, has an objective of providing a method for providing an illumination service and an illumination apparatus which can provide an entertaining factor.

The present invention has another objective of providing a recording medium which is readable by such an illumination apparatus and is capable of controlling the illumination apparatus so as to provide entertainment.

The present invention has still another objective of providing a recording medium which can control an illumination apparatus so as to provide an entertaining factor.

The present invention has still another objective of providing a reproduction apparatus capable of reproducing illumination control data which is recorded on a recording medium in synchronization with the reproduction of sound data and/or video data which is recorded on the recording medium.

The present invention has still another objective of providing a reproduction apparatus capable of reproducing received illumination control data in synchronization with the reproduction of received sound data and/or video data.

### DISCLOSURE OF THE INVENTION

A method of the present invention is a method for providing an illumination service using an illumination apparatus for illuminating a prescribed space with a desired form and a computer. The illumination apparatus includes a plurality of pixels which are independently controllable. The method includes the steps of the computer receiving an order for an illumination service; the computer obtaining illumination control data for controlling the plurality of pixels included in the illumination apparatus in accordance with the order for the illumination service; and the computer providing the illumination control data. The above objectives are achieved by this.

The step of the computer providing the illumination control data may include the step of the computer directly transmitting the illumination control data to the illumination apparatus.

The illumination service may be a service for displaying a message with illumination by the illumination apparatus.

The illumination service may be a service for displaying an illumination pattern with illumination by the illumination apparatus.

An illumination apparatus of the present invention is an illumination apparatus for illuminating a prescribed space with a desired form. The illumination apparatus includes a plurality of pixels which are independently controllable; an interface section for receiving illumination control data for controlling the plurality of pixels from outside the illumination apparatus; and a control section for controlling the plurality of pixels in accordance with the illumination control data.

The interface section may include a network communication section connected to a network; and the network communication section may receive the illumination control data via the network.

The interface section may include a recording medium accessing section for accessing a recording medium; and the recording medium accessing section ma read the illumination control data recorded on the recording medium so as to receive the illumination control data from the recording medium.

Each of the plurality of pixels may include a light emitting diode (LED).

A recording medium of the present invention is a recording medium having illumination control data, recorded thereon, for controlling a plurality of independently controllable pixels which are included in an illumination apparatus.

A reproduction apparatus of the present invention includes a dividing section for receiving stream data including encoded AV data and encoded illumination control data, and dividing the stream data into the encoded AV data and the encoded illumination control data; an AV data decoding section for decoding the encoded AV data so as to output AV data; and an illumination control data decoding section for decoding the encoded illumination control data so as to output illumination control data. The AV data includes at least one of audio data and video data, and the illumination control data is data for controlling a plurality of pixels included in the illumination apparatus.

The reproduction apparatus may further include a control section for controlling the AV data decoding section and the illumination control data decoding section. The control section may control the AV data decoding section and the illumination control data decoding section, such that a timing of the decoding or the output performed by the AV data decoding section and a timing of the decoding or the output performed by the illumination control data decoding section are synchronized with each other.

The reproduction apparatus may further include a read section for reading information recorded on a recording medium; and a stream data generation section for generating the stream data based on an output from the read section.

The reproduction apparatus may further include a receiving section for receiving information transmitted from a transmission apparatus; and a stream data generation section for generating the stream data based on an output from the receiving section.

The receiving section may receive the information which is transmitted from the transmission apparatus in the form of broadcasting.

The receiving section may receive the information which is transmitted from the transmission apparatus via a network.

The stream data may further include information indicating which illumination apparatus has a pixel arrangement that is suitable to the illumination control data.

### BRIEF DESCRIPTION OF THE DRAWINGS

FIG. 1 is a block diagram illustrating a structure of a system 100 providing an illumination service according to a first example of the present invention.

FIG. 2 is a block diagram illustrating a structure of an illumination apparatus 10 according to the present invention.

FIG. 3A shows an exemplary structure of one pixel 16 of the illumination apparatus 10.

FIG. 3B shows another exemplary structure of one pixel 16 of the illumination apparatus 10.

FIG. 3C shows still another exemplary structure of one pixel 16 of the illumination apparatus 10.

FIG. 4 shows a state in which the illumination apparatus 10 is located in a house 102.

FIG. 5 is a flowchart illustrating a procedure of providing an illumination service which is executed by a CPU 2 of a service center 1.

FIG. 6A shows an example of a web page 601 acting as an interface when a user 301 transmits an order 121 to the service center 1.

FIG. 6B shows an example of a web page 610 for introducing illumination services.

FIG. 6C shows an example of a web page 620 displaying a list of message display services.

FIG. 6D shows an example of a web page 630 to allow the user 301 to order from the service center 1 a “happy birthday” message display service.

FIG. 6E shows an example of a web page 645 displaying a list of illumination pattern display services.

FIG. 6F shows an example of a web page 650 displaying a list of illumination patterns for “situation illumination”.

FIG. 6G shows an example of a web page 660 displaying a list of illumination patterns with the theme of “nature”.

FIG. 6H shows an example of a web page 670 to allow the user 301 to order from the service center 1 an illumination service with the theme of “grassland”.

FIG. 7A shows an exemplary structure of illumination control data 131.

FIG. 7B shows an exemplary structure of luminance data of a specific pixel.

FIG. 7C shows how the luminance of LEDs 17R, 17G and 17B is controlled by luminance data shown in FIG. 7B.

FIG. 8 shows an example of a message displayed on the illumination apparatus 10.

FIG. 9A illustrates how sunlight filters through the leaves of a tree.

FIG. 9B shows a ground 906 illuminated with the sunlight filtering through the leaves.

FIG. 10A shows how a floor 1006 of a room is illuminated with the illumination apparatus 10 installed on a ceiling.

FIG. 10B shows the floor 1006 illuminated with illumination light 51.

FIG. 11A shows areas on the floor 1006 illuminated with two pixels included in the illumination apparatus 10.

FIG. 11B shows an example of controlling the brightness of pixels 16-1 and 16-2.

FIG. 12 shows a change in the state of the floor 1006 when the brightness of the pixels 16-1 and 16-2 is controlled as shown in FIG. 11B.

FIG. 13 shows an exemplary scent control apparatus 1300 for controlling the scent of a room illuminated with the illumination apparatus 10.

FIG. 14 is a block diagram illustrating an exemplary structure of a reproduction apparatus 2100 according to a second example of the present invention.

FIG. 15 shows a format of data recorded on a DVD 2110.

FIG. 16 shows a format of VMG and VTS.

FIG. 17 shows a format of VOBS.

FIG. 18 shows a format of a pack conforming to the MPEG-PS system.

FIG. 19 shows a schematic structure of a digital satellite broadcasting system 3001.

FIG. 20 shows a format of a transport stream conforming to the MPEG-TS system.

FIG. 21 is a block diagram illustrating an exemplary structure of an IRD 3017 according to a third example of the present invention.

### BEST MODE FOR CARRYING OUT THE INVENTION

Hereinafter, the present invention will be described by way of examples with reference to the attached drawings.

### EXAMPLE 1

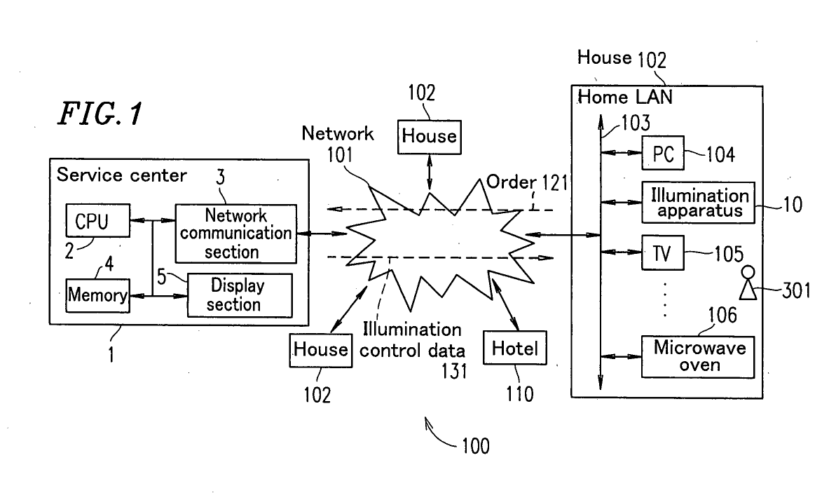

FIG. 1 shows a structure of a system 100 providing an illumination service according to a first example of the present invention.

The system 100 includes a service center 1, a house 102, and a network 101 for connecting the service center 1 and the house 102. The network 101 may be connected to a hotel 110. The network 101 is an arbitrary network (for example, the Internet). The network 101 may include various types of LAN including wireless LAN, WAN, telephone line, wireless telephone line and the like.

In the house 102, devices (household electronic information devices) such as a personal computer (PC) 104, an illumination apparatus 10 and the like are located. In the house 102, further devices such as a TV 105, a microwave oven 106 and the like may be located. These devices are connected to each other via a home LAN 103 installed in the house 102. The home LAN 103 is connected to the network 101.

The illumination apparatus 10 includes a plurality of pixels which are independently controllable.

In the house 102, a user 301 of these devices leads his/her life. The user 301 uses, for example, a PC 104 to transmit an order 121 for an illumination service to the service center 1. The transmitted order 121 is received by the service center 1 via the network 101.

The service center 1 includes a network communication section 3 for communicating with the devices in the house 102 via the network 101, a CPU 2, a memory 4 and a display section 5. The service center may be an arbitrary computer.

The CPU 2 generates (obtains) appropriate illumination control data 131 in accordance with the order 121 for the illumination service received by the network communication section 3, and executes illumination service provision processing by providing the illumination control data 131 to the illumination apparatus 10.

In the memory 4, for example, illumination control data for displaying a plurality of template messages and illumination patterns is stored for each model of the illumination apparatus. The “illumination pattern” refers to a pattern, displayed on the illumination apparatus, which defines a form of illumination for each pixel of the illumination apparatus (for example, color and/or brightness of illumination light of each pixel). The form of illumination may be changed time-wise (moving picture) or may not be changed (still picture).

The display section 5 is used by the administrator of the service center 1 (computer) to monitor the state of the service center 1. The display section 5 is, for example, a CRT display.

The communication between the service center 1 and the illumination apparatus 10 located in the house 102 is performed by, for example, packet transfer. A packet includes a header section representing a destination of transfer, and a data section carrying data to be transferred (for example, the illumination control data 131). The header section is, for example, assigned to each device located in the house 102, and includes an address uniquely specifying the respective device on the network 101. An IP address assigned to each device in accordance with IPv6 (Internet Protocol Version 6), for example, is used as such an address. An IP address uniquely specifies, on the Internet, a device connected to the Internet.

By such a structure of the header section of packets, a packet can be transferred from the service center 1 to a specific illumination apparatus 10 located in the house 102, or from a specific illumination apparatus 10 located in the house 102 to the service center 1.

In the hotel 110, as in the house 102, devices (household electronic information devices) such as a personal computer (PC) 104, an illumination apparatus 10 and the like are located.

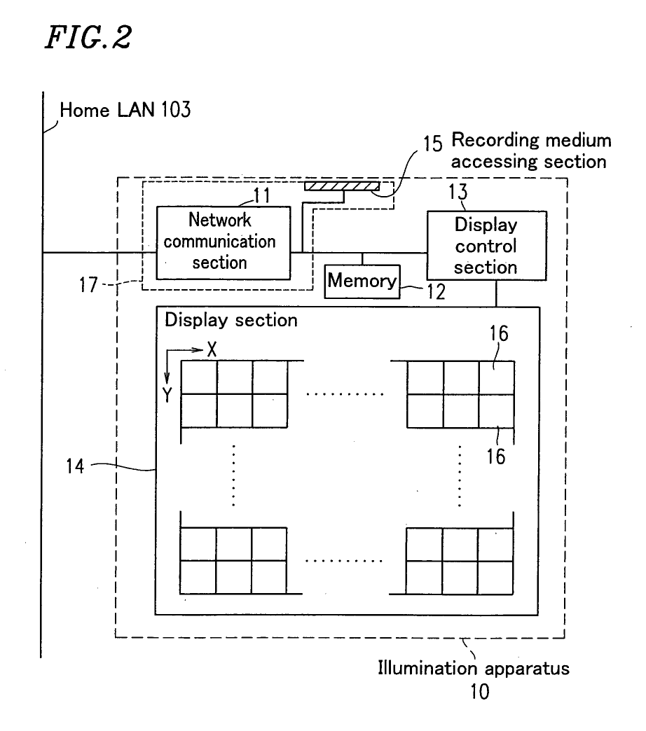

FIG. 2 shows a structure of an illumination apparatus 10 according to the present invention. The illumination apparatus 10 is connected to the home LAN 103. The illumination apparatus 10 includes a network communication section 11 for receiving the illumination control data 131 via the network 101, a display section 14 including a plurality of pixels 16 which are independently controllable, and a display control section 13 for controlling the plurality of pixels 16 in accordance with the received illumination control data 131. The illumination apparatus 10 may include a memory 12 for storing the illumination control data 131 received by the network communication section 11.

The form of the illumination apparatus 10 receiving the illumination control data 131 is not limited to the form of receiving the illumination control data 131 from the network communication section 11 via the home LAN 103. The illumination apparatus 10 may include a recording medium accessing section 15 instead of, or in addition to, the network communication section 11. The recording medium accessing section 15 reads the illumination control data 131 recorded on a recording medium, thus receiving the illumination control data 131 from the recording medium.

In the case where the illumination apparatus 10 includes the recording medium accessing section 15, the illumination control data 131 transmitted from the service center 1 may be recorded on the recording medium. The user 301 connects a recording medium having desired illumination control data 131 recorded thereon to the recording medium accessing section 15, and thus can illuminate a room in which the illumination apparatus 10 is located with a desired form of illumination at a desired time.

As a recording medium on which the illumination control data 131 is to be recorded, an arbitrary recording medium is usable. For example, recording mediums such as a hard disc, CD-ROM, MO, MD, DVD, SD card and the like are preferably usable.

The network communication section 11 or the recording medium accessing section 15 act as an interface section 17 for receiving the illumination control data 131 from outside the illumination apparatus 10.

The display control section 13 generates a control signal for controlling the plurality of pixels 16 of the display section 14 from the illumination control data 131. In the case where each of the plurality of pixels includes a light emitting diode (LED), the display control section 13 generates a pulse voltage signal for driving the LED as a control signal.

The display section 14 includes the plurality of pixels 16. The plurality of pixels 16 are arranged, for example, in a matrix. The number of pixels 16 included in the display section 14 is, for example, about 500. Each of the pixels 16 emits illumination light. The display control section 13 independently controls the brightness and the color of illumination light emitted by each of the plurality of pixels 16. Thus, various forms of illumination are realized. The various forms of illumination include normal forms of illumination (which are not required to have an entertaining factor) and forms of illumination which are required to have an entertaining factor.

In the normal forms of illumination (which are not required to have an entertaining factor), the display control section 13 controls the pixels 16 such that each of the pixels 16 emits white illumination light at a maximum luminance regardless of the illumination control data 131. Thus, the brightness and the average color rendering evaluation index of illumination provided by the illumination apparatus 10 can be increased.

In the forms of illumination which are required to have an entertaining factor, the display control section 13 controls the plurality of pixels 16 in accordance with the illumination control data 131. Thus, a prescribed space, for example, a room can be illuminated with a desired form. In such a form of illumination, the illumination apparatus 10 displays, for example, an illumination pattern.

In this manner, the display control section 13 controls the illumination apparatus 10 so as to have, as operation modes, a first operation mode in which the illumination apparatus 10 operates in a normal form of illumination and a second operation mode in which the illumination apparatus 10 operates in a form required to have an entertaining factor. The display section 13 may control the illumination apparatus 10 so as to operate only in the second operation mode.

In this specification, the “illumination apparatus” refers to an arbitrary apparatus for illuminating a prescribed space with a desired form. It does not matter whether or not the illumination apparatus was designed with an intention to illuminate a prescribed space with a desired form. Even if the main purpose of the apparatus is not to illuminate a prescribed space with a desired form, but results in illuminating the prescribed space with a desired form, that apparatusis an “illuminationapparatus”. For example, display apparatuses (for example, liquid display devices (LCDs) or plasma display devices (PDPs)) are “illumination apparatuses”. The reason is that a display apparatus illuminates a prescribed space with a desired form by light emitted by the display panel.

The arrangement of the plurality of pixels 16 is not limited to the matrix as shown in FIG. 2. The plurality of pixels 16 may be arranged in a delta. The arrangement of the plurality of pixels 16 may be freely changeable. The position of each of the plurality of pixels 16 may be independently changeable.

The display section 14 maybe divided into a plurality of separate blocks. The separate blocks may be located at different positions. For example, one block may be located on a wall while another block may be located on a ceiling.

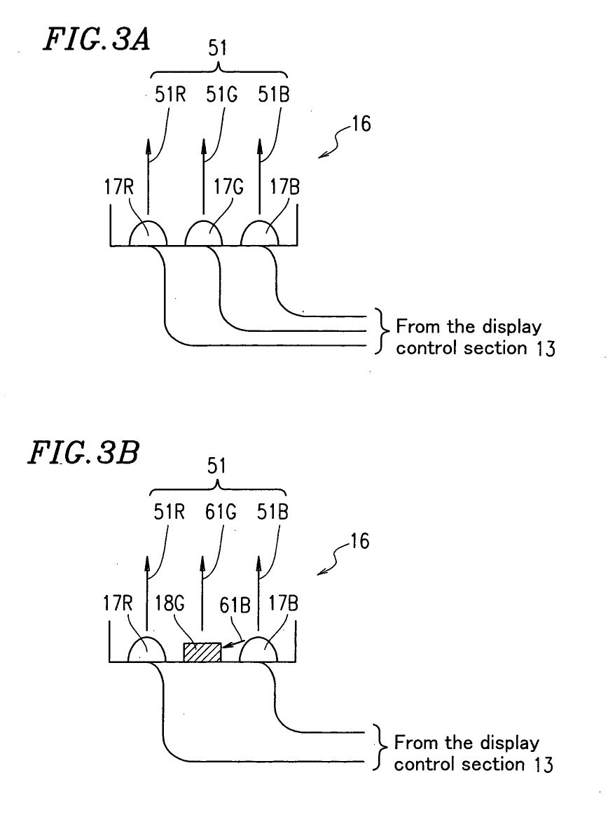

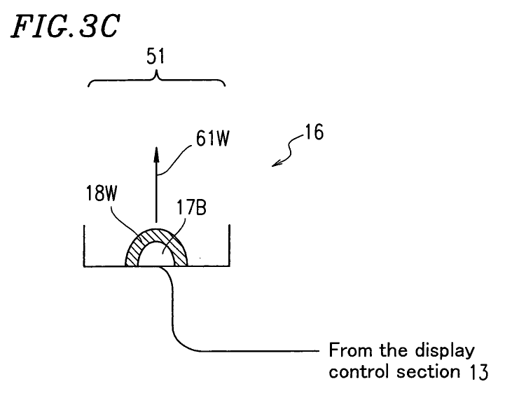

FIG. 3A shows an exemplary structure of one pixel 16 of the illumination apparatus 10. The pixel 16 includes three LEDs 17R, 17G and 17B. The LEDs 17R, 17G and 17B are each connected to the display control section 13. The LEDs 17R, 17G and 17B respectively emit red light 51R, green light 51G and blue light 51B. The red light 51R, the green light 51G and the blue light 51B collectively form illumination light 51 which is emitted by the pixel 16.

The display control section 13 independently controls the luminance of the LEDs 17R, 17G and 17B, and thus the illumination light 51 emitted by the pixel 16 can be controlled to have a desired brightness and color. The luminance of each of the LEDs 17R, 17G and 17B can be controlled by controlling a pulse voltage signal for driving the respective LED 17R, 17G or 17B and thus changing the amount of current flowing in the respective LED 17R, 17G or 17B.

FIG. 3B shows another exemplary structure of one pixel 16 of the illumination apparatus 10. In FIG. 3B, identical elements previously discussed with respect to FIG. 3A bear identical reference numerals and the detailed descriptions thereof will be omitted. In the example shown in FIG. 3B, the pixel 16 includes two LEDs 17R and 17B. In the vicinity of the LED 17B, a green fluorescent element 18G is provided. The green fluorescent element 18G is illuminated by a part 61B of light emitted by the LED 17B and thus emits green fluorescent light 61G. The light 51R, the light 61G and light 51B collectively form illumination light 51 which is emitted by the pixel 16.

The structure of the pixel 16 shown in FIG. 3B does not need the LED 17G as compared with the structure shown in FIG. 3A and thus can reduce the cost of the illumination apparatus 10 (FIG. 2). It should be noted, however, that the color reproducibility of the illumination light 51 emitted by the pixel 16 having the structure shown in FIG. 3B is inferior to that of the illumination light 51 emitted by the pixel 16 having the structure shown in FIG. 3A.

FIG. 3C shows still another exemplary structure of one pixel 16 of the illumination apparatus 10. In FIG. 3C, identical elements previously discussed with respect to FIG. 3A bear identical reference numerals and the detailed descriptions thereof will be omitted. In the example shown in FIG. 3C, the pixel 16 includes one LED 17B. A white fluorescent element 18W is applied to the LED 17B so as to cover the LED 17B. The white fluorescent element 18W is illuminated by the blue light emitted by the LED 17B and thus emits white fluorescent light 61W. The white fluorescent light 61W forms illumination light 51 which is emitted by the pixel 16.

The structure of the pixel 16 shown in FIG. 3C can change the brightness of the illumination light 51 emitted by the pixel 16 but cannot change the color of the illumination light 51. The structure of the pixel 16 shown in FIG. 3C can reduce the cost of the illumination apparatus 10 (FIG. 2) as compared to the structures shown in FIGS. 3A and 3B. The pixel structure shown in FIG. 3C is preferable to uses in which the color of the illumination light 51 does not need to be changed.

The structure of pixels included in the illumination apparatus 10 is not limited to those shown in FIGS. 3A through 3C. Instead of the LEDs, organic EL light emitting elements or plasma light emitting elements may be used. The illumination apparatus 10 may control a conventional fluorescent lamp and/or an incandescent lamp in addition to the plurality of pixels 16 which are independently controllable. The illumination apparatus 10 may, for example, provide overall illumination of a room with a fluorescent lamp and local illumination of the room with a plurality of pixels 16 which are independently controllable.

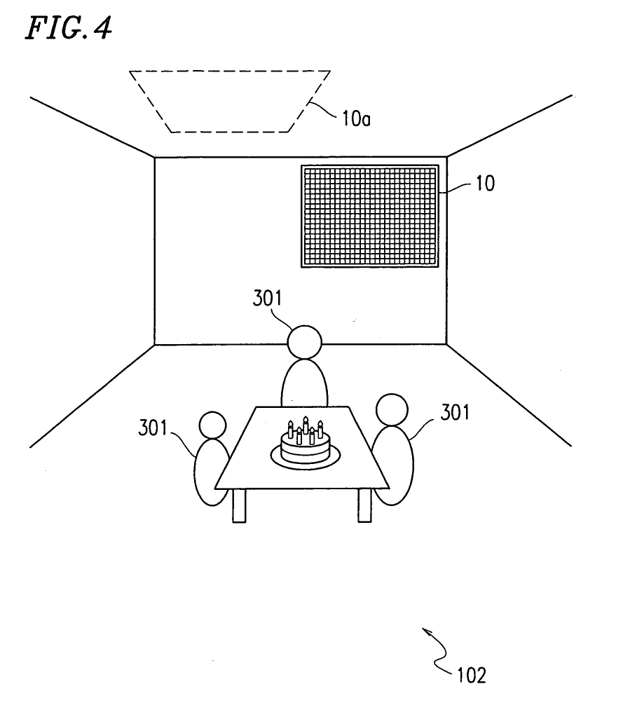

FIG. 4 shows a state in which the illumination apparatus 10 is located in the house 102. In the example shown in FIG. 4, the illumination apparatus 10 is installed on a wall of a room in which users 301 spend time. The illumination apparatus 10 may be installed in a position 10a on the ceiling of the room.

The illumination apparatus 10 may be installed at a prescribed position of a bathroom (for example, on a wall). The illumination apparatus 10 may display an illumination pattern creating a mind healing effect (for example, an illumination pattern representing “Mt. Fuji” or “firefly”). In such a case, the body relaxing effect provided by bathing and the mind healing effect can be improved synergistically.

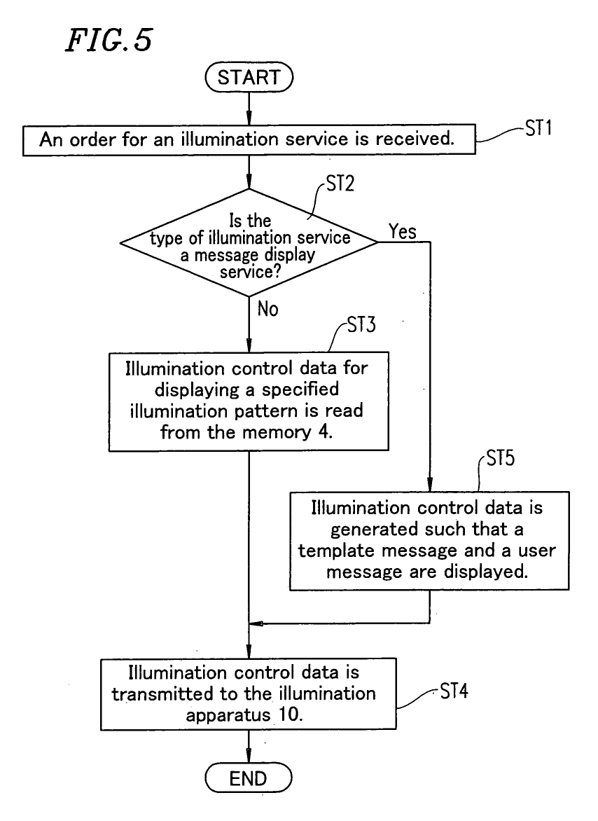

FIG. 5 shows a procedure of providing an illumination service, which is executed by the CPU 2 in the service center 1.

Step ST1: An order for an illumination service (order 121) is received. The order 121 is transmitted, for example, by the user 301 (FIG. 1) from the PC 104 in the house 102 via the home LAN 103 and the network 101. The transmitted order 121 is received by the network communication section 3.

The order 121 includes, for example, specification of a type of illumination service. Types of illumination service include, for example, a “message display service” or an “illumination pattern display service”. In the following description, there are two types of illumination services, i.e., the “message display service” and the “illumination pattern display service” unless otherwise specified.

The order 121 is made by specifying an illumination apparatus (illumination apparatus of a transmission destination to which the illumination service is to be transmitted). The illumination apparatus is specified by, for example, specifying an address assigned to the illumination apparatus.

When the user 301 specifies the “message display service” as the type of illumination service, the user 301 specifies a template message and a user message to be displayed on the illumination apparatus. The “template message” is a message selected by the user 301 among messages prepared by the service center 1. The “user message” is an arbitrary message created by the user 301.

When the user 301 specifies the “illumination pattern display service”, the user 301 specifies an illumination pattern to be displayed on the illumination apparatus among illumination patterns prepared by the service center 1.

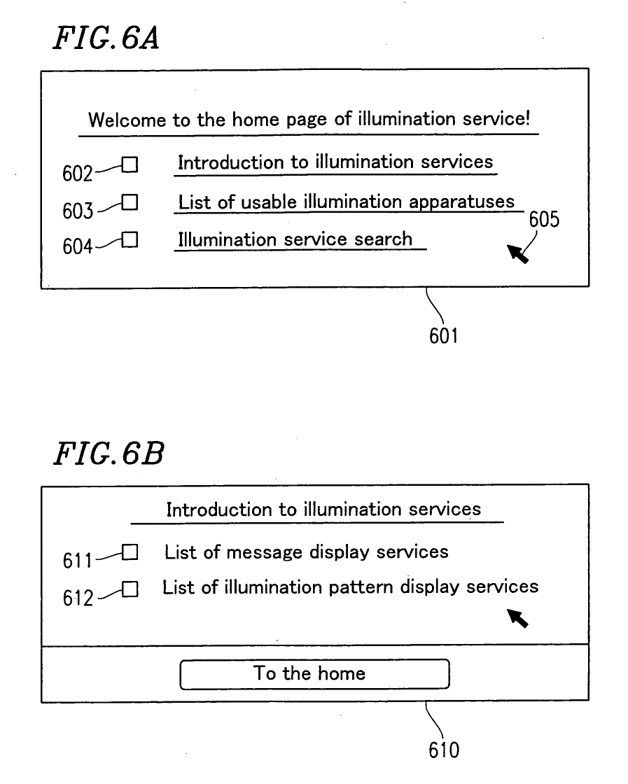

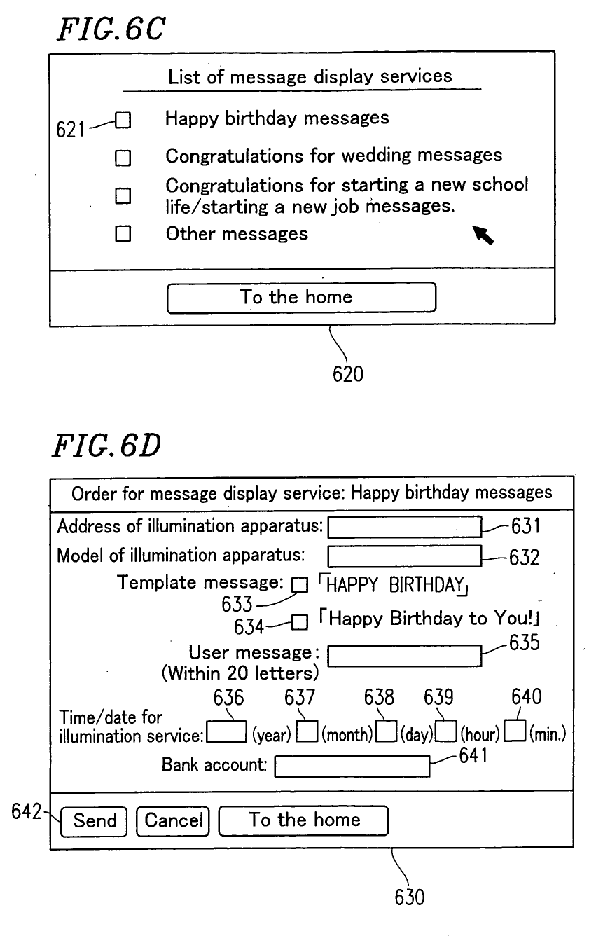

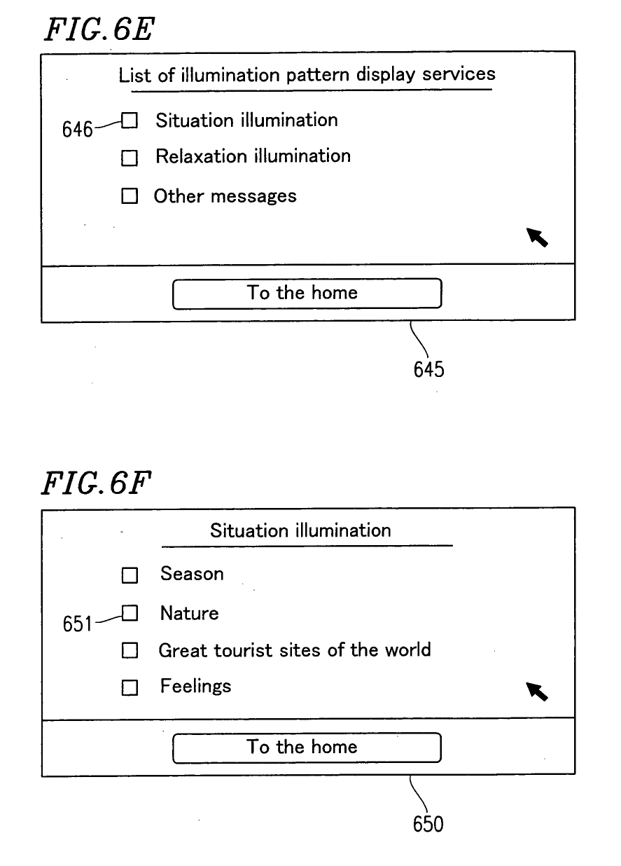

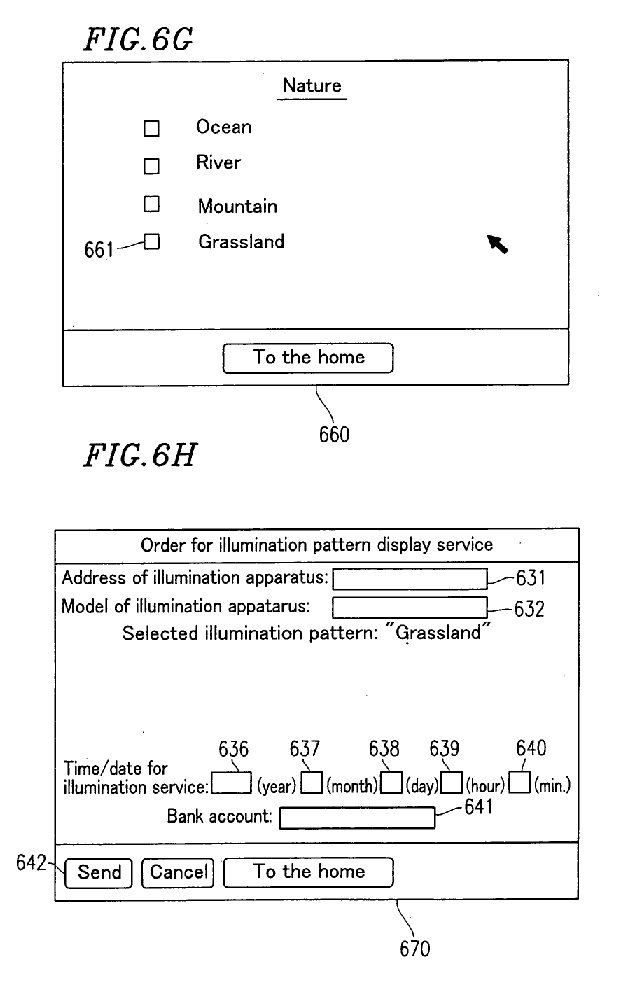

The user 301 can transmit the order 121 using, for example, web pages described below with reference to FIGS. 6A through 6H. Such web pages are provided by the service center 1.

Step ST2: It is determined whether the type of illumination service included in the order 121 is the “message display service” or not. When the result of determination in step ST2 is “Yes”, the processing goes to step ST5. When the result of determination in step ST2 is “No”, theprocessing goes to step ST3.

Step ST3: Illumination control data 131 for displaying the specific illumination pattern is read from the memory 4 (database) (FIG. 1), and thus the illumination control data 131 is obtained. The illumination control data 131 may be read in consideration of the model of the illumination apparatus on which the illumination pattern is to be displayed. In this way, even when the shape or size of the display surface is different for each model of illumination apparatus, illumination control data 131 which is suitable for each model can be read. In this case, the illumination service order 121 received in step ST1 may include specification of a model of illumination apparatus.

Step ST4: The illumination control data 131 is transmitted to the illumination apparatus at the transmission destination included in the illumination service order 121 received in step ST1. The transmitted illumination control data 131 is received by the illumination apparatus 10 via the network 101 and the home LAN 103 (FIG. 1).

In this example, the illumination control data 131 is directly transmitted to the illumination apparatus 10 (without being transmitted through any device other than the illumination apparatus). The illumination control data 131 may be provided to the illumination apparatus 10 at the transmission destination by indirect transmission. For example, the illumination control data 131 maybe transmitted to the PC 104 located in the house 102. The illumination control data 131 received by the PC 104 is transferred at an appropriate time either automatically or manually by the user 301. The illumination control data 131 may be transmitted to a cellular phone (including a PHS phone) of the user 301. The illumination control data 131 received by the cellular phone can be transferred to the illumination apparatus 10 by, for example, wireless communication.

Step ST5: The illumination control data 131 is created such that the template message and the user message are displayed on the display surface of the illumination apparatus, and thus the illumination control data 131 is obtained. The illumination control data 131 may be created in consideration of the model of the illumination apparatus on which the illumination pattern is to be displayed. In this way, even when the shape or size of the display surface is different for each model of illumination apparatus, illumination control data 131 which is suitable for each model can be created.

Either step ST3 or ST5 acts as a step for obtaining the illumination control data 131 for controlling the plurality of pixels 16 included in the illumination apparatus 10 in accordance with the illumination service order 121.

As a user interface which is to be used by the user 301 for transmitting the order 121 (FIG. 1) to the service center 1, any user interface is applicable. In consideration of accessibility, a web page on the world wide web is preferable as the user interface.

FIG. 6A shows an example of a web page 601 acting as a user interface used by the user 301 for transmitting the order 121 to the service center 1.

The web page 601 is described with an arbitrary description language (for example, the HTML language). A file for describing the web page 601 is stored in the memory 4 of the service center 1. The file has a URL address which uniquely specifies a position on the network 101 at which the file is stored. The user 301 inputs the URL address to a web page browsing software which is executed by the PC 104, so that the web page 601 is displayed on the PC 104.

The web page 601 includes buttons 602 through 604. The user 301 selects any of the “introduction to illumination services” button 602, the “list of usable illumination apparatuses” button 603, and the “illumination service search” button 604 (for example, the user 301 clicks a mouse connected to the PC 104 with a mouse pointer 605 pointing to any of the buttons). Then, the web page corresponding to the selected button is displayed on the PC 104.

FIG. 6B shows an example of a web page 610 which introduces illumination services. The web page 610 is displayed on the PC 104 when, for example, the user 301 selects the “introduction to illumination services” button 602 on the web page 601 shown in FIG. 6A.

The web page 610 includes a “list of message display services” button 611 and a “list of illumination pattern display services” button 612.

FIG. 6C shows an example of a web page 620 which displays the list of message display services. The web page 620 is displayed on the PC 104 when, for example, the user 301 selects the “list of message display services” button 611 on the web page 610 shown in FIG. 6B.

FIG. 6C shows that the following messages can be displayed on the illumination apparatus by the message display services provided by the service center 1: “happy birthday” messages, “congratulations for wedding” messages, “congratulations for starting a new school life/starting a new job” messages, and “other” messages.

FIG. 6D shows an example of a web page 630 by which the user 301 can order a message display service for a “happy birthday” message. The web page 630 is displayed on the PC 104 when, for example, the user 301 selects a “happy birthday” button 621 on the web page 620 shown in FIG. 6C.

The web page 630 includes areas 631 through 641 and a send button 642. When the user 301 inputs necessary information in each of the areas 631 through 641 and then selects the send button 642, the order 121 is transmitted to the service center 1. Thus, the illumination service provision processing shown in FIG. 5 is started.

An address input in the area 631 by the user 301 for specifying an illumination apparatus on which the message is to be displayed is, for example, an IP address assigned to the illumination apparatus. In the area 631, an address of an arbitrary device which is a transmission destination of the illumination control data 131 (for example, the PC 104 of the user 301) may be input.

In the area 632, the model of the illumination apparatus is input. In the case where the address of the illumination apparatus is input in the area 631 and the service center 1 has a database describing the correspondence between the addresses of the illumination apparatuses and the models, or the service center 1 can access such a database, it is not necessary to input the model in the area 632. The reason is that the model of the illumination apparatus can be obtained using the address of the illumination apparatus input in the area 631 and the database.

One of the areas 633 and 634 is selected by the user 301 depending on whether the user 301 prefers the template message “HAPPY BIRTHDAY” or the template message “Happy Birthday to You!”. In the example shown in FIG. 6D, there are two template messages, but there may be more template messages. By increasing the number of template messages, the user 301 can have more choices.

In the area 635, the user message is input.

The areas 636 through 640 are used for specifying the time/day at which the illumination service is to be provided, i.e., the time/day at which the specified message is to be displayed on the illumination apparatus 10. Such display may be realized by Method (1), according to which the service center 1 provides the illumination control data 131 to the illumination apparatus 10 at the specified time/day and the illumination apparatus 10 which has received the illumination control data 131 immediately displays the message based on the illumination control data 131. Alternatively, such display may be realized by Method (2), according to which the service center 1 immediately provides the illumination control data 131 to the illumination apparatus 10 upon obtaining the illumination control data 131 and the illumination apparatus 10 which has received the illumination control data 131 displays the message based on the illumination control data 131 on the specified time/day. In this case, the service center 1 provides the illumination apparatus 10 with the illumination control data 131 as well as the information representing the time/day at which the message is to be displayed. When the transmission destination of the illumination control data 131 is not an illumination apparatus, Method (2) is used.

The user 301 inputs the time/day at which the illumination service is to be provided in the areas 636 through 640, such that the illumination service is provided at a desired time on a desired day (for example, the birthday of a family member of the user 301).

When no data is input in the areas 636 through 640, the service center 1 immediately transmits the illumination control data 131 to the illumination apparatus 10 upon obtaining the illumination control data 131, and the illumination apparatus 10 which has received the illumination control data 131 immediately displays the message based on the illumination control data 131. Accordingly, the message is displayed on the illumination apparatus 10 immediately after the order 121 is transmitted.

In the area 641, a bank account of the user 301 is input. The illumination service is charged to the bank account specified here.

FIG. 6E shows an example of a web page 645 which displays a list of illumination pattern display services. The web page 645 is displayed on the PC 104 when, for example, the user 301 selects the “list of illumination pattern display services” button 612 on the web page 610 shown in FIG. 6B.

FIG. 6E shows that the following patterns can be displayed on the illumination apparatus as the illumination pattern display services provided by the service center 1: “situation illumination” patterns, “relaxation illumination” patterns, and “other” illumination patterns.

FIG. 6F shows an example of a web page 650 which displays a list of illumination patterns for the “situation illumination”. The web page 650 is displayed on the PC 104 when, for example, the user 301 selects a “situation illumination” button 646 on the web page 645 shown in FIG. 6E.

FIG. 6F shows that as the “situation illumination” patterns, illumination pattern shaving the themes of “season”, “nature”, “great tourist sites of theworld”, and “feelings” are available.

FIG. 6G shows an example of a web page 660 which displays a list of illumination patterns with the theme of “nature”. The web page 660 is displayed on the PC 104 when, for example, the user 301 selects a “nature” button 651 on the web page 650 shown in FIG. 6F.

An illumination pattern with the theme of “nature” is an illumination pattern which reminds the user 301 of nature when the illumination pattern is displayed on the illumination apparatus 10.

FIG. 6G shows that as illumination patterns with the theme of “nature”, illumination patterns with the themes of “ocean”, “river”, “mountain” and “grassland” are available.

FIG. 6H shows an example of a web page 670 by which the user 301 can order an illumination service with the theme of “grassland”. The web page 670 is displayed on the PC 104 when, for example, the user 301 selects a “grassland” button 661 on the web page 660 shown in FIG. 6G.

The web page 670 includes areas 631, 632, 636 through 641 and a send button 642. These areas and send button are identical to the areas and send button having the same reference numerals shown in FIG. 6D and will not be described here.

By using the web pages shown in FIGS. 6A through 6H as a user interface for transmitting an illumination service order, the user 301 can transmit the illumination service order from any terminal connectable to the Internet. The user 301 can place an order such that the illumination control data 131 is provided to an illumination apparatus 10 located in somebody else's house. The user 301 can also place an order such that the illumination control data 131 is provided to the illumination apparatus 10 located in his/her house from outside the house.

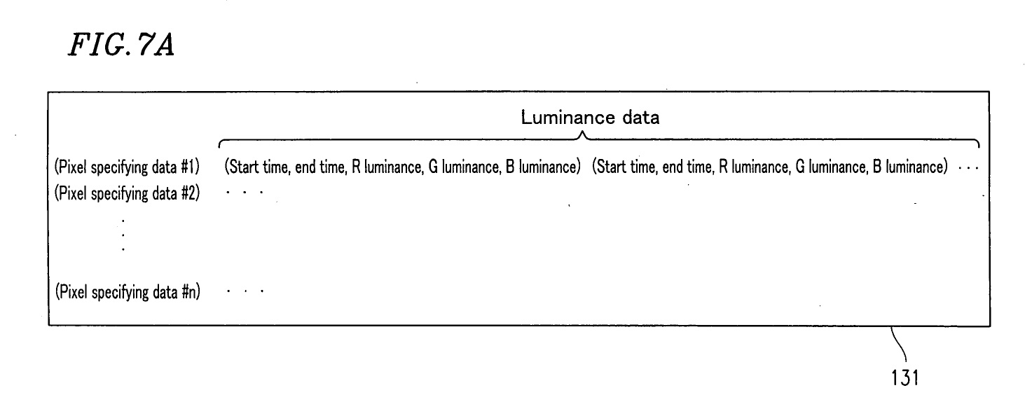

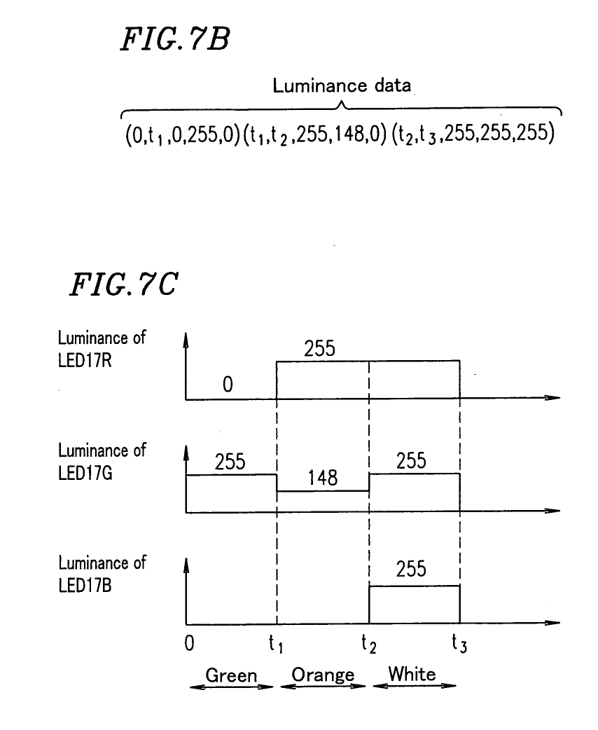

FIG. 7A shows an exemplary structure of the illumination control data 131. In the example shown in FIG. 7A, luminance data is specified for each of the pixel specifying data #1 through pixel specifying data #n. Each of the pixel specifying data #1 through pixel specifying data #n respectively correspond to the plurality of pixels 16 included in the display section 14 of the illumination apparatus 10 (FIG. 2). It is assumed here that each of the plurality of pixels 16 has a structure shown in FIG. 3A for the sake of illustration.

Each of the pixel specifying data #1 through pixel specifying data #n specifies a corresponding pixel based on, for example, the X-Y coordinates shown in FIG. 2. For example, the pixel specifying data corresponding to the pixel located at the upper left corner of the display surface shown in FIG. 2 is represented as (1,1).

The luminance data includes at least one list. Each of the at least one list is represented as “start time, end time, R luminance, G luminance, B luminance”. This list indicates that the LEDs 17R, 17G and 17B are respectively set to the “R luminance”, “G luminance” and “B luminance” from the “start time” to the “end time”.

The luminance of each of the LEDs 17R, 17G and 17B is represented by 0 through 255 luminance levels (256 levels).

FIG. 7B shows an exemplary structure of the luminance data for a specific pixel. In the example shown in FIG. 7B, from time 0 to time t₁, the luminance of the LEDs 17R, 17G and 17B is set to 0, 255 and 0, respectively. From time t₁ to time t₂, the luminance of the LEDs 17R, 17G and 17B is set to 255, 148 and 0, respectively. From time t₂ to time t₃, the luminance of the LEDs 17R, 17G and 17B is set to 255, 255 and 255, respectively.

FIG. 7C shows how the luminance of the LEDs 17R, 17G and 17B is controlled by the luminance data shown in FIG. 7B. When the luminance of the LEDs 17R, 17G and 17B included in one pixel 16 is controlled as shown in FIG. 7C, the illumination light 51 emitted by the pixel 16 looks green from time 0 to time t₁, orange from time t₁ to time t₂, and white from time t₂ to time t₃. The luminance of the LEDs 17R, 17G and 17B for realizing these colors is not limited to that as shown in FIG. 7C. For example, the luminance of each of the LEDs 17R, 17G and 17B may be adjusted in consideration of the sensitivity of the human eye (sight characteristic) such that the “green” light, “orange” light and “white” light look as having approximately the same brightness to the human eye.

According to the illumination control data 131 shown in FIG. 7A, luminance data is specified for each of the plurality of pixels 16. Therefore, the plurality of pixels 16 can be independently controlled. Thus, the illumination control data 131 represents the illumination pattern displayed on the illumination apparatus 10.

The structure of the illumination control data 131 is not limited to that shown in FIG. 7A. The illumination control data 131 may have any data structure which can independently control the plurality of pixels 16 included in the illumination apparatus 10 (FIG. 2). The number of levels to which the LEDs included in each pixel is controlled is not limited to 256.

When an illumination pattern includes a pattern which is repeated time-wise, each of the patterns can be represented by common data. In this way, the size of the illumination control data 131 can be reduced.

The illumination control data 131 may have a data structure which does not depend on the structure of the illumination apparatus 10. For example, the illumination control data 131 may have a data structure which does not depend on the number of pixels in the horizontal and vertical directions (e.g., 1024 (horizontal)×768 (vertical), 1280 (horizontal)×768 (vertical), etc.) of the display section 14 of the illumination apparatus 10. In this case, the illumination control data 131 can be applied to an illumination apparatus 10 having an arbitrary structure. Also in this case, it is not necessary to store the illumination control data 131 in the memory 4 of the service center 1 for each model of illumination apparatus.

The display control section 13 may have a function of appropriately converting the illumination control data for an illumination apparatus having a different structure and displaying the converted data on the display section 14. For example, the display control section 13 may have a function of converting the illumination control data for an illumination apparatus having 1024 (horizontal)×768 (vertical) pixels and displaying the converted data on the display section 14 having a 1280 (horizontal)×768 (vertical) pixels. Such a conversion may be, for example, enlargement or reduction performed using interpolation. Such a conversion may be realized by repeating the same pattern spatially.

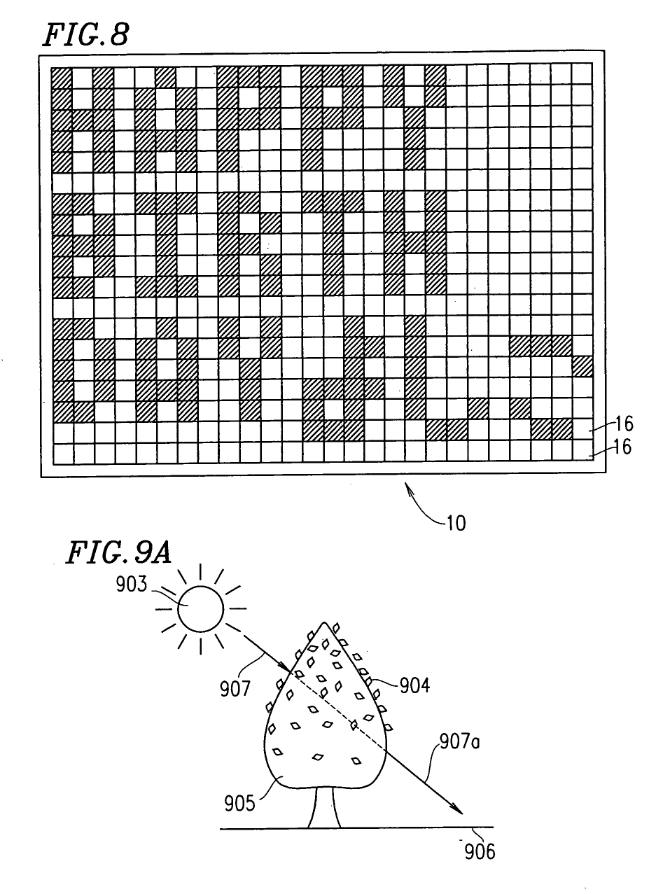

FIG. 8 shows an example of a message displayed on the illumination apparatus 10. In FIG. 8, the pixels 16 represented by white squares are pixels 16 emitting white illumination light, and the pixels 16 represented by hatched squares are pixels 16 which are off.

The display section 14 represent the message “HAPPY BIRTHDAY [symbol] (Yoshiko)”. “HAPPYBIRTHDAY” is the template message, and “ [symbol] ” is the user message.

The message shown in FIG. 8 can be displayed on the illumination apparatus 10, for example, at the starting time of a birthday party held for a family member (for example, a daughter). The people who will attend the birthday party are not informed that such a message will be displayed on the illumination apparatus 10. If such a message is displayed on the illumination apparatus 10 at the starting time of the birthday party, the participants will be surprised and excited. Thus, the illumination apparatus 10 can provide entertainment.

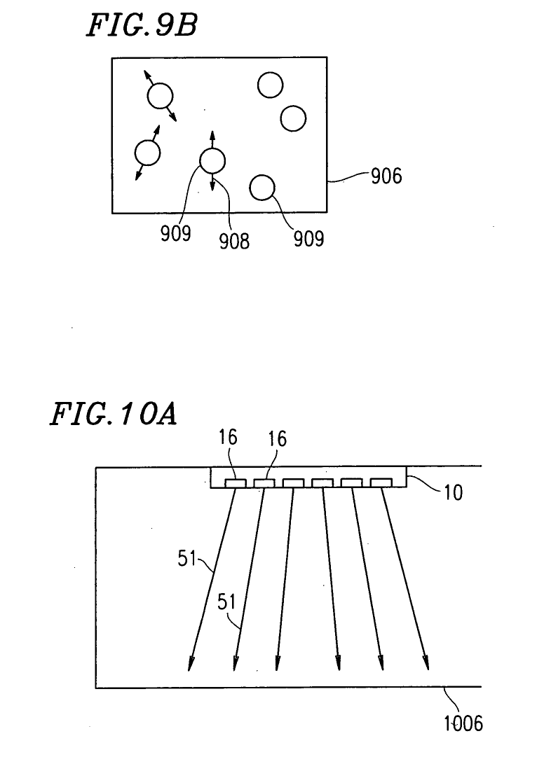

Hereinafter, with reference to FIGS. 9A, 9B, 10A, 10B, 11A, 11B and 12, examples of displaying an illumination pattern on the illumination apparatus 10 will be described. In the examples below, an illumination pattern with the theme of “grassland” is displayed on the illumination apparatus 10. With this illumination pattern, the illumination apparatus 10 reproduces sunlight filtering through leaves of a tree in the grassland.

FIG. 9A illustrates how sunlight filters through the leaves of a tree. A light ray 907 emitted by the sun 903 goes through a tree 905 and reaches the ground 906. The light ray 907 is obstructed by leaves 904, and a light ray 907a filtering through the leaves 904 reaches the ground 906.

FIG. 9B shows the ground 906 illuminated with the light ray 907a. The ground 906 has areas 909 brighter than the remaining area in correspondence with each light ray 907a.

FIG. 10A shows a floor 1006 of a room illuminated with the illumination apparatus 10 installed on the ceiling.

Each of the pixels 16 of the illumination apparatus 10 emits the illumination light 51. The illumination light 51 is set to have a color as close as possible to the color of the light ray 907 emitted by the sun. Each of the pixels 16 has a relatively high directivity. Namely, one ray of the illumination light 51 illuminates a relatively small area on the floor 1006.

Such a high directivity is realized by, for example, collecting the light emitted by the LEDs included in the pixel 16 in a specific direction using a reflective mirror, an optical fiber, or the like. In order to realize the high directivity, a semiconductor laser may be used instead of the LED.

FIG. 10B shows a state of the floor 1006 illuminated with the illumination light 51. Each of circular areas 910 is an area on the floor illuminated with the illumination light 51 emitted by one of the pixels 16. Each of the circular areas 910 corresponds to each of the pixels 16 of the illumination apparatus 10. In FIG. 10B, each of the white circles represents an area of the floor 1006 illuminated with the corresponding pixel 16 which is on. Each of the hatched circles indicates that the corresponding pixel 16 is off. Namely, the white circles in FIG. 10B each show a bright area on the floor 1006.

The plurality of pixels 16 included in the illumination apparatus 10 are controlled so as to be in the same positional relationship as that of the bright areas 909 shown in FIG. 9B. Thus, the floor 1006 can be illuminated in the same form as that of the ground 906 illuminated with the light filtering through the leaves.

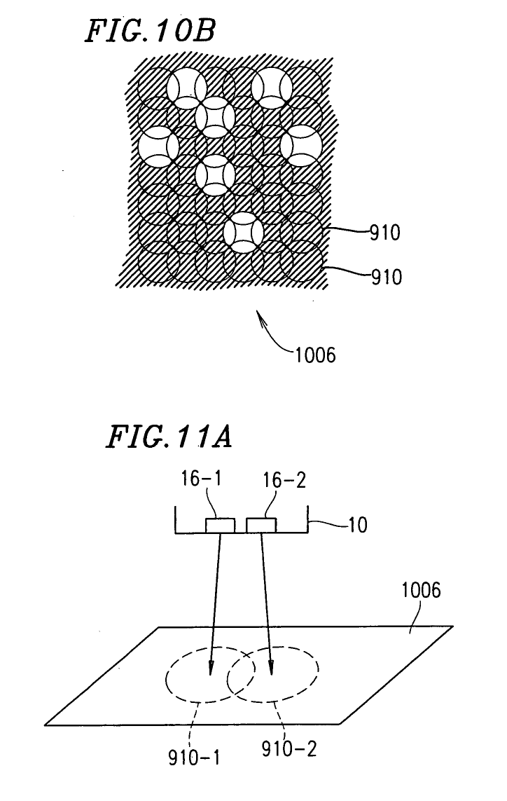

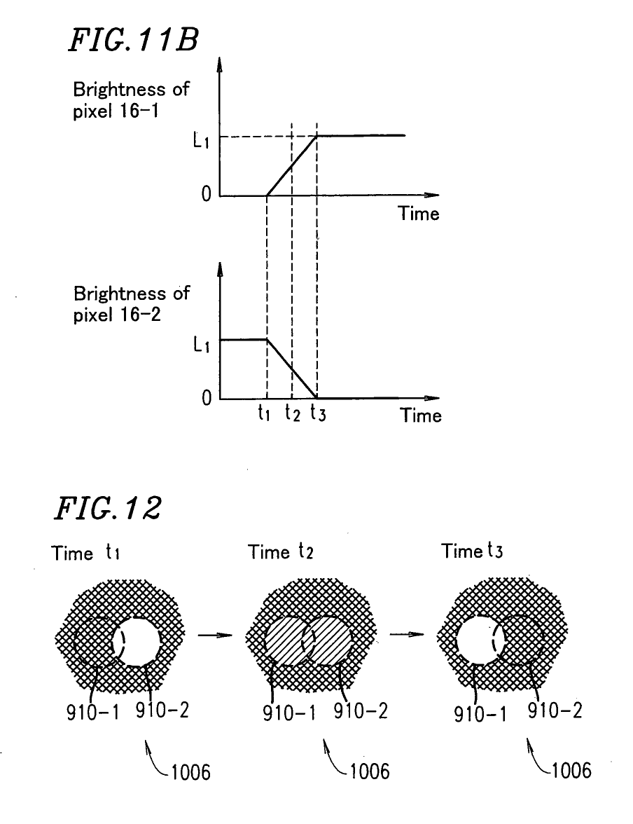

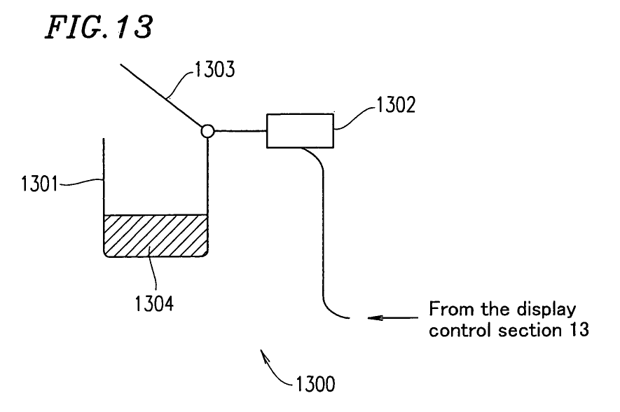

With the actual light filtering through the leaves, the bright areas 909 on the ground 906 move as shown by arrows 908 (FIG. 9B) as the leaves 904 sway with the wind. With reference to FIGS. 11A, 11B and 12, an example of realizing such a movement with the illumination apparatus 10 will be described.

FIG. 11A shows areas on the floor 1006 illuminated with two pixels included in the illumination apparatus 10. In the example shown in FIG. 11A, an area 910-1 on the floor 1006 is illuminated with a pixel 16-1, and an area 910-2 on the floor 1006 is illuminated with a pixel 16-2.

FIG. 11B shows an example of controlling the brightness of the pixels 16-1 and 16-2. It is assumed that each of the pixels 16-1 and 16-2 has a structure shown in FIG. 3A. The brightness of each pixel is derived from the luminance of the three LEDs included in the pixel.

In the example shown in FIG. 11B, the brightness of the pixel 16-1 gradually increases from level L0 to L₁ from time t₁ to time t₃, and the brightness of the pixel 16-2 gradually decreases from level L₁ to L0 from time t₁ to time t₃. Namely, the illumination pattern is displayed on the illumination apparatus 10 such that the brightness changes as the time passes. The luminance of the LEDs included in each pixel is controlled such that the color of the illumination light emitted by the pixels 16-1 and 16-2 does not change while the brightness of the pixels 16-1 and 16-2 gradually increases or decreases.

FIG. 12 shows a change in the state of the floor 1006 when the brightness of the pixels 16-1 and 16-2 is controlled as shown in FIG. 11B.

At time t₁, only the area 910-2 is illuminated with the pixel 16-2.

At time t₂ (t₁<t₂<t₃), the areas 910-1 and 910-2 are respectively illuminated with the pixels 16-1 and 16-2. The luminance of each of the pixels 16-1 and 16-2 is lower than the luminance of the pixel 16-2 at time t₁.

At time t₃, only the area 910-1 is illuminated with the pixel 16-1.

When the state of the areas 910-1 and 910-2 changes in this manner, the human eye perceives that the bright area moves from the area 910-2 to the area 910-1 from time t₁ to time t₃. By applying this principle to the white circles shown in FIG. 10B, the human eye is led to perceive that the white circles (bright areas) sway. Thus, the movement of actual light filtering through the leaves can be realized by the illumination apparatus 10.

By displaying such an illumination pattern on the illumination apparatus 10, the user 301 present in the room illuminated with the illumination apparatus 10 is expected to feel refreshed or relaxed as if he/she was actually in the grassland. Thus, the illumination apparatus 10 provides entertainment.

The illumination pattern is not limited to the example described above with reference to FIGS. 9A, 9B, 10A, 10B, 11A, 11B and 12. For example, a landscape painting may be displayed on the illumination apparatus 10 as an illumination pattern.

In the above-described example, a message or an illumination pattern is displayed on the illumination apparatus 10. The message and the illumination pattern may be displayed together. For example, a message may be displayed on the background of the illumination pattern. The brightness and/or the color of the pixels forming the letters of the message may be changed as the time passes.

As the illumination pattern displayed on the illumination apparatus 10 changes, the scent of the room illuminated with the illumination apparatus 10 may be changed.

FIG. 13 shows an exemplary scent control apparatus 1300 for controlling the scent of the room illuminated with the illumination apparatus 10.

The scent control apparatus 1300 is additionally provided in the illumination apparatus 10 and is connected to the display control section 13. The scent control apparatus 1300 includes a motor 1302, a perfume bottle 1301, and a lid 1303. The perfume bottle 1301 accommodates perform 1304.

In the case where the illumination apparatus 10 includes the scent control apparatus 1300, the illumination control data 131 provided to the illumination apparatus 10 includes data for controlling the motor 1302. The motor 1302 operates to open or close the lid 1303. When the lid 1303 is opened, the scent emitted by the perfume 1304 fills the room in which the illumination apparatus 10 is located. The strength of the scent is controlled by adjusting the degree by which the lid 1303 is opened.

Controlling the scent of the room in accordance with the time-wise change in the illumination pattern can make the user 301 feel refreshed or relaxed. Thus, a higher level of entertainment can be provided.

In the example shown in FIG. 13, the illumination apparatus 10 controls one type of scent. When a plurality of scent control apparatuses 1300 having different types of perfume 1304 are used, the illumination apparatus 10 can control a plurality of types of scent. When the lids 1303 of the plurality of scent control apparatuses 1300 are opened at the same time, many types of scent can be provided. Thus, a still higher level of entertainment can be provided.

The illumination pattern displayed on the illumination apparatus 10 may be changed in association with music and/or video provided by broadcasting or a recording medium.

In order to change the illumination pattern in association with music and/or video provided by broadcasting, for example, illumination control data representing the illumination pattern is transmitted together with the broadcasting using a streaming technology. The illumination control data thus transmitted can be received by an appropriate broadcast receiver and transferred to the illumination apparatus 10. Alternatively, more simply, while a program is being broadcast, title information of illumination control data representing an illumination pattern which is suitable to be combined with the program is informed to the user 301.

In order to change the illumination pattern in association with music and/or video provided by a recording medium (for example, a DVD), for example, illumination control data is recorded on the recording medium together with data representing the music and/or video. The illumination control data thus recorded can be reproduced by an appropriate reproduction apparatus and transferred to the illumination apparatus.

### EXAMPLE 2

In a second example of the present invention, a reproduction apparatus capable of reproducing illumination control data recorded on a recording medium in synchronization with the reproduction of sound data and/or video data recorded on the recording medium will be described. By connecting the reproduction apparatus to a sound output apparatus (for example, a speaker), a video output apparatus (for example, a TV) and an illumination apparatus, the illumination pattern can be changed in association with the music and/or video provided by the recording medium.

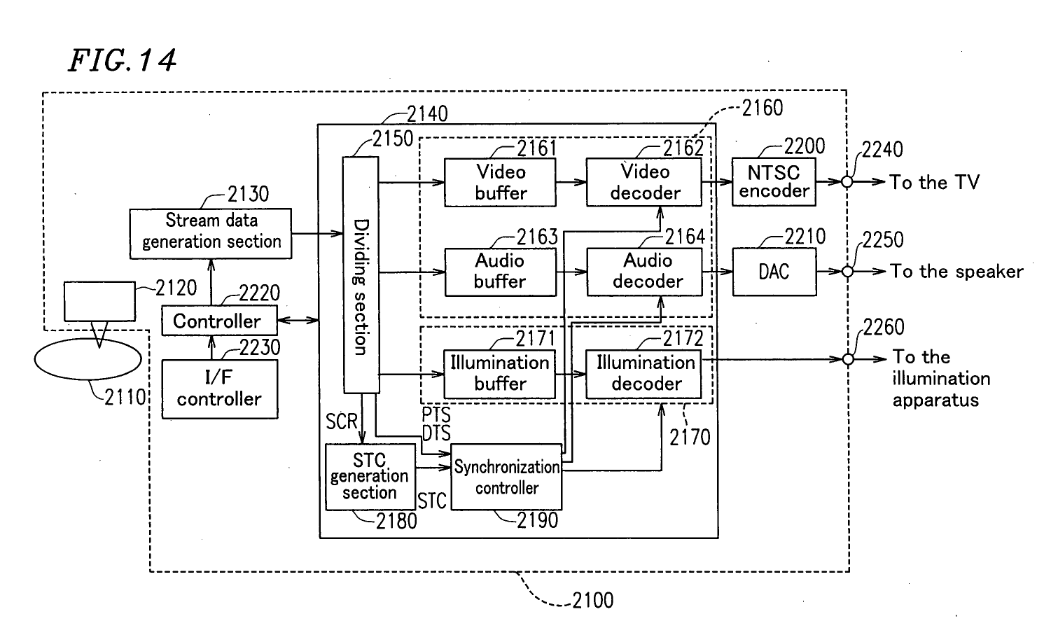

FIG. 14 shows an exemplary structure of a reproduction apparatus 2100 according to the second example of the present invention.

The reproduction apparatus 2100 includes a controller 2220, an interface controller (I/F controller) 2230, and a read section 2120.

The controller 2220 controls the entire operation of the reproduction apparatus 2100 based on an operation command input by the user to the I/F controller 2230 and a control signal provided from a decoding section 2140.

The I/F controller 2230 detects an operation of the user (for example, press of an operation button) and outputs an operation command corresponding to that operation to the controller 2220.

The read section 2120 reads information which is recorded on a recording medium 2110.

The recording medium 2110 is typically a DVD (Digital Versatile Disc), but is not limited to a DVD. The recording medium 2110 may be any type of recording medium. In the following description, the recording medium 2110 is a DVD. In this case, the read section 2120 is, for example, an optical pickup.

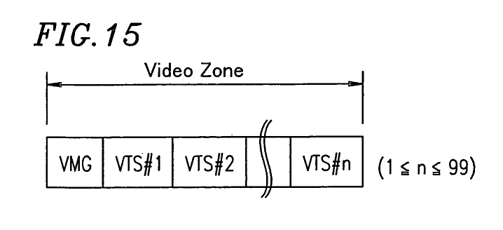

FIG. 15 is a data format recorded on the DVD 2110.

In a video zone of the DVD 2110, one video manager (VMG: Video Manager) and at least one but no more than 99 video title sets (VTS: Video Title Set) VTS#1 through VTS#n are recorded. Here, n is any integer fulfilling 1≦n≦99. A VMG is located at the start of the video zone of the DVD 2110 and includes two or three files. Each of VTS#1 through VTS#n includes at least three but no more than 12 files.

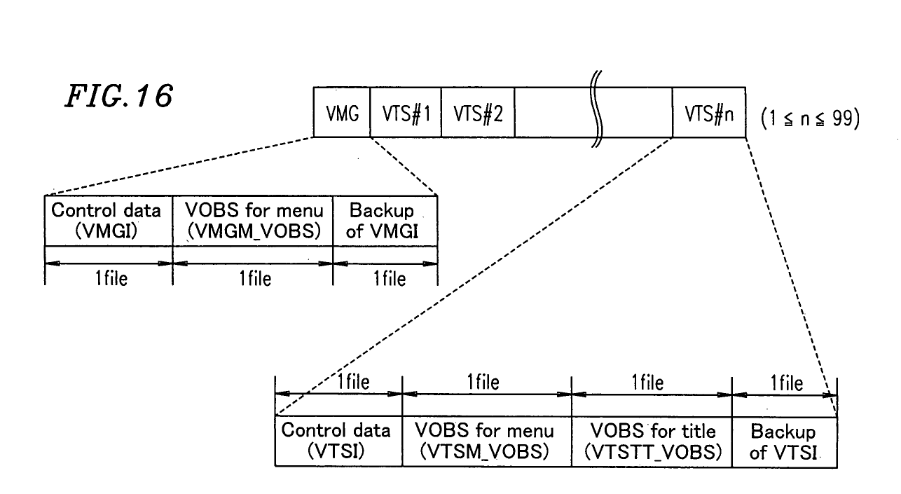

FIG. 16 is a format of a VMG or a VTS.

In the example shown in FIG. 16, a VMG includes three files. In the first file in the VMG, control data (VMGI: Video Manager Information) acting as navigator data is recorded. In the next file in the VMG, VOBS for menu (VMGM_VOBS: VMGM Video Object Set) is recorded. In the last file in the VMG, a backup file of the VMGI is recorded. The VMGI is information for managing a VMG menu (VMGM: VMG Menu) and at least one VTS.

In the example shown in FIG. 16, a VTS includes four to 12 files. In the first file in the VTS, control data (VTSI: Video Title Set Information) acting as navigation data is recorded. In the next file in the VTS, VOBS for menu (VTSM_VOBS: VTSM Video Object Set) is recorded. In the next files (the number of files is any of 1 through 9) in the VST, VOBS for title (VTSTT_VOBS: VTSTT Video Object Set) is recorded. In the last file in the VTS, a backup file of the VTSI is recorded. The VTSI is information for managing a VTS menu (VTSM: Video Title Set Menu) and at least one title (TT: Title).

The “VOBS for menu” and “VOBS for title” are both a type of VOBS (Video Object Set). Accordingly, the “VOBS for menu” and “VOBS for title” each has a VOBS format.

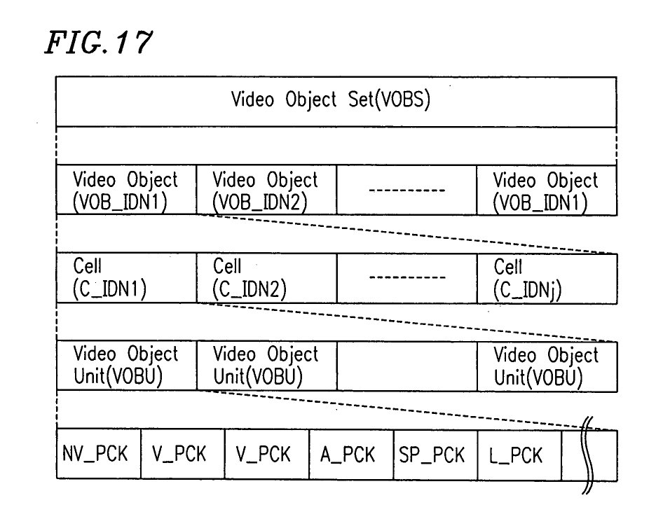

FIG. 17 shows a VOBS format.

A VOBS includes at least one VOB (Video Object). In each VOB in the VOBS, aVOB ID number (VOB_IDN: VOB ID number) is assigned, sequentially from the VOB recorded in a sector having the minimum logical sector number in the VOBS (LSN: Logical Sector Number).

Each of the at least one VOB includes at least one Cell. In each Cell of the VOB, a cell ID number (C_IDN: Cell ID number) is assigned, sequentially from the Cell recorded in a sector having the minimum logical sector number in the VOB (LSN: Logical Sector Number).

Each of the at least one Cell includes at least one VOBU (Video Object Unit).

Each of the at least one VOBU includes at least one Pack. Each of the at least one Pack may be an audio pack (A_PCK: Audio Pack), a video pack (V_PCK: Video Pack), a sub picture pack (SP_PCK: Sub-picture Pack), or a navigation pack (NV_PCK: Navigation Pack). NV_PCK is located at the start of the VOBU.

Data in the NV_PCK is navigation data (i.e., reproduction control data). Data in the A_PCK, V_PCK, and SP_PCK is presentation data (i.e., data for reproducing the video, audio, sub-picture and the like).

The above-described data format conforms to the DVD-Video Standards. According to the present invention, a format modified from the DVD-Video format is used. In other words, according to the present invention, in a VOBU, lighting pack (L_PCK: Lighting Pack) is newly provided. Data in the L_PCK is data for outputting illumination control data in synchronization with the presentation data.

MPEG-2 (Moving Picture Experts Group 2) defines two systems as a system for multiplexing an arbitrary number of encoded streams and reproducing the streams in synchronization with each other. The two systems are a program stream (PS: Program Stream) system and a transport stream (TS: Transport Stream) system. In a digital storage medium such as a DVD, the program stream (PS: Program Stream) system is used. In the following description, the program stream (PS: Program Stream) system defined by MPEG-2 is briefly referred to as the “MPEG-PS system”, and the transport stream (TS: Transport Stream) system defined by MPEG-2 is briefly referred to as the “MPEG-TS system”.

The NV_PCK, A_PCK, V_PCK, and SP_PCK all adopt a format conforming to the MPEG-PS system. Accordingly, the L_PCK added by the present invention also adopts a format conforming to the MPEG-PS system.

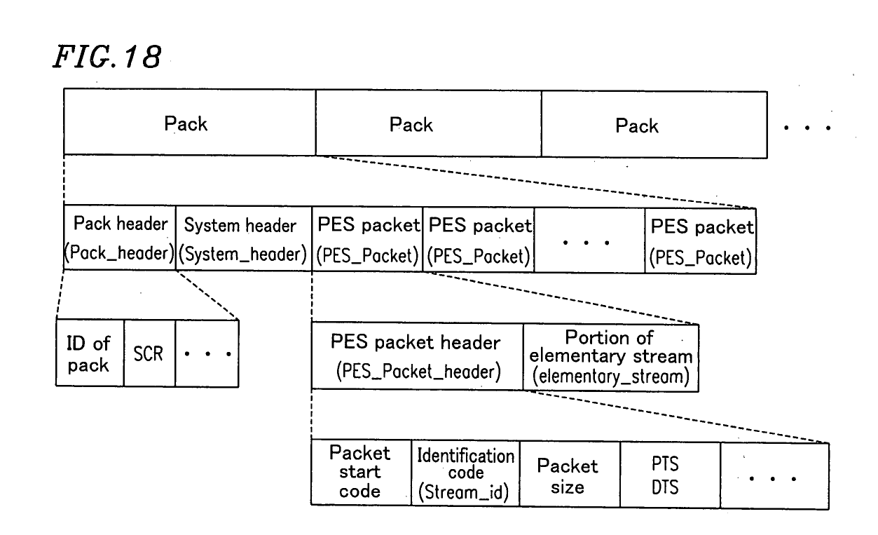

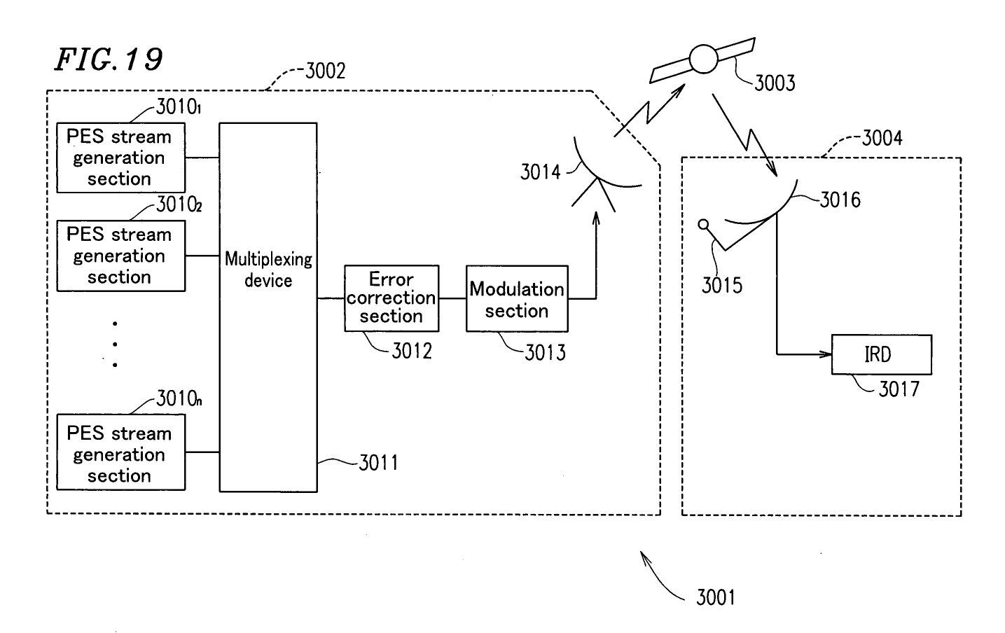

FIG. 18 shows a format of a pack conforming to the MPEG-PS system.

Each pack includes a pack header (Pack_header), a system header (System_header), and at least one PES packet (PES_Packet). Here, PES is an acronym of Packetized Elementary Stream.

In the pack header, an ID, reference time information (SCR: System Clock Reference), multiplication bit rate (mux_rate) and the like of the pack are described. By MPEG-2, it is permitted to add a maximum of 7 stuffing bytes to the pack header in order to adjust the length of the pack.

Each of the at least one PES includes a PES packet header (PES_Packet_Header) and one of a plurality of portions which are obtained by dividing the elementary stream (elementary_stream). An “elementary stream” is a data stream which is individually encoded for each data type such as video data, sound data, illumination control data and the like.

In the PES packet header, a packet start code, an identification code (stream_id) for identifying the elementary stream, a packet size, time information for synchronously reproducing elementary streams, other control information and the like are described. The time information for synchronously reproducing elementary streams is represented by a presentation time stamp (PTS: Presentation Time Stamp) or a decoding time stamp (DTS: Decoding Time Stamp).

For each of video data and sound data, a decoding and reproduction unit referred to as the “access unit” is predetermined. The access unit of video data is 1 frame (picture), and the access unit of sound data is 1 audio frame. The access unit of illumination control data is, for example, the same as the access unit of video data (i.e., 1 frame (picture)). In a DTS, time information which indicates at which point in the reference time the decoding should be performed is described for each access unit. In a PTS, time information which indicates at which point in the reference time the reproduction should be performed is described for each access unit.

Returning to FIG. 14, the reproduction apparatus 2100 further includes a stream data generation section 2130 and a decoding section 2140.

The stream data generation section 2130 generates stream data including encoded AV data and encoded illumination control data, based on the output from the read section 2120. In this specification, the “encoded AV data” refers to data including at least one of encoded sound data and encoded video data.

The stream data generated by the stream data generation section 2130 has a format conforming to the MPEG-PS system (see FIG. 18). Such stream data is obtained by, for example, receiving information recorded in the DVD 2120 in the form of an RF signal, digitalizing and amplifying the RF signal, and subjecting the RF signal to EFM and decoding processing. The structure of the stream data generation section 2130 can be identical with a known structure, and will not be described in detail.

The decoding section 2140 includes a dividing section 2150, an AV data decoding section 2160, an illumination control data decoding section 2170, an STC generation section 2180 and a synchronization controller (control section) 2190.

The dividing section 2150 receives stream data having a format conforming to the MPEG-PS system from the stream data generation section 2130 and divides the stream data into encoded AV data and encoded illumination control data. Such division is performed by referring to the identification code (stream_id) in the PES packet header. The dividing section 2150 is, for example, a demultiplexer.

The AV data decoding section 2160 outputs AV data by decoding the encoded AV data. In this specification, “AV data” refers to data including at least one of sound data and video data.

The AV data decoding section 2160 includes a video buffer 2161 for temporarily storing encoded video data which is output from the dividing section 2150, a video decoder 2162 for decoding the encoded video data to output video data, an audio buffer 2163 for temporarily storing encoded sound data which is output from the dividing section 2150, and an audio decoder 2164 for decoding the encoded sound data to output sound data.

The illumination control data decoding section 2170 outputs illumination control data by decoding the encoded illumination control data. The “illumination control data” has the same meaning as that of the illumination control data 131 described in the first example. Accordingly, the illumination control data is data for controlling the plurality of pixels 16 included in the illumination apparatus 10. The illumination control data may have a format shown in FIG. 7A.

The illumination control data decoding section 2170 includes an illumination buffer 2171 for temporarily storing the encoded illumination control data which is output from the dividing section 2150, and an illumination decoder 2172 for decoding the encoded illumination control data to output illumination control data.

The STC generation section 2180 generates an STC (System Time Clock). An STC is obtained by adjusting (i.e., increasing or decreasing) the frequency of a 27 MHz reference clock based on the SCR. An STC is obtained by reproducing reference time which was used when the data was encoded, the reproduction being performed when the encoded data was decoded.

The synchronization controller 2190 controls the AV data decoding section 2160 and the illumination control data decoding section 2170, such that the timing at which the AV data decoding section 2160 outputs the AV data and the timing at which the illumination control data decoding section 2170 outputs the illumination control data are synchronized with each other.

Such a control for synchronized reproduction is achieved, for example, by the following. The video decoder 2162 is controlled to output an access unit of video data when the STC and the PTC match each other, the audio decoder 2164 is controlled to output an access unit of sound data when the STC and the PTC match each other, and the illumination decoder 2172 is controlled to output an access unit of illumination control data when the STC and the PTC match each other.

The synchronization controller 2190 may control the AV data decoding section 2160 and the illumination control data decoding section 2170, such that the timing at which the AV data decoding section 2160′ decodes the AV data and the timing at which the illumination control data decoding section 2170 decodes the illumination control data are synchronized with each other.

Such a control for synchronized reproduction is achieved, for example, by the following. The video decoder 2162 is controlled to decode an access unit of video data when the STC and the DTS match each other, the audio decoder 2164 is controlled to decode an access unit of sound data when the STC and the DTS match each other, and the illumination decoder 2172 is controlled to decode an access unit of illumination control data when the STC and the DTS match each other.

As described above, instead of, or in addition to, controlling the timing at which the access units of video data, sound data and illumination control data is output, the timing at which the access units of the video data, the sound data and the illumination control data is decoded may be controlled. The reason is that the timing (order) at which the access unit is output and the timing (order) at which the access unit is decoded may be different in some cases. By such a control, the video data, the sound data, and the illumination control data can be synchronously reproduced.

The video data which is output from the video decoder 2162 is output to an external device (for example, a TV) via an NTSC encoder 2200. The video decoder 2162 and the TV may be connected to each other directly via an output terminal 2240 of the reproduction apparatus 2100 or indirectly via the home LAN 103 (FIG. 1).

The sound data which is output from the audio decoder 2164 is output to an external device (for example, a speaker) via a digital/analog converter (DAC) 2210. The audio decoder 2164 and the speaker may be connected to each other directly via an output terminal 2250 of the reproduction apparatus 2100 or indirectly via the home LAN 103 (FIG. 1).

The illumination control data which is output from the illumination decoder 2172 is output to an external device (for example, the illumination apparatus 10 shown in FIG. 1). The illumination decoder 2172 and the illumination apparatus 10 may be connected to each other directly via an output terminal 2260 of the reproduction apparatus 2100 or indirectly via the home LAN 103 (FIG. 1). When the illumination decoder 2172 and the illumination apparatus 10 are connected to each other directly via the output terminal 2260 of the reproduction apparatus 2100, the interface section 17 of the illumination apparatus 10 is structured to be capable of being connected to the output terminal 2260 of the reproduction apparatus 2100. When the illumination decoder 2172 and the illumination apparatus 10 are connected to each other indirectly via the home LAN 103, a network communication section which is communicable with the network communication section 11 (FIG. 2) of the illumination apparatus 10 is added at a stage after the illumination decoder 2172 of the reproduction apparatus 2100.

The stream data generated by the stream data generation section 2130 may include encoded sub video data and may include navigation data. For example, when the stream data includes encoded sub video data and navigation data, the dividing section 2150 divides the stream data into the sub video data and the navigation data. Although not shown in FIG. 14, the decoding section 2140 may further include a navigation pack circuit, a sub picture decoder, a closed caption data decoder. The navigation pack circuit generates a control signal by processing the navigation data and outputs the control signal to the controller 2220. The sub picture decoder decodes the encoded sub video data so as to output sub video data to the NTSC encoder 2200. The closed caption data decoder decodes encoded closed caption data which is included in the encoded video data so as to output closed caption data to the NTSC decoder 2200. The functions of these circuits are known and are not directly relevant to the present invention, and will not be described in detail. Thus, the decoding section 2140 may include known elements which are not shown in FIG. 14.

As described above, according to the second example, a reproduction apparatus capable of reproducing illumination control data recorded on a recording medium in synchronization with reproduction of sound data and/or video data recorded on the recording medium is provided. By connecting the reproduction apparatus to a sound output apparatus (for example, a speaker), a video output apparatus (for example, a TV) and an illumination apparatus, an illumination pattern can be changed in association with the music and/or video provided by the recording medium.

### EXAMPLE 3

In a third example of the present invention, a reproduction apparatus capable of reproducing received illumination control data in synchronization with the reproduction of received sound data and/or video data will be described. By connecting the reproduction apparatus to a sound output apparatus (for example, a speaker), a video output apparatus (for example, a TV) and an illumination apparatus, the illumination pattern can be changed in association with the music and/or video provided by broadcasting.

FIG. 19 shows an exemplary structure of a digital satellite broadcasting system 3001 according to the third example of the present invention.

The digital satellite broadcasting system 3001 includes a transmission apparatus 3002, a satellite 3003, and a receiving apparatus 3004. The transmission apparatus 3002 transmits a signal to the satellite 3003. The receiving apparatus 3004 receives the signal transmitted to the satellite 3003 and converts the received signal into a reproduceable signal.

The transmission apparatus 3002 includes PES stream generation sections 3010₁, 3010₂, . . . 3010ₙ, a multiplexing device 3011, an error correction section 3012, a modulation section 3013, and a transmission antenna 3014.

Each of the PES stream-generation sections 3010₁, 3010₂, . . . 3010ₙ multiplexes two or more elementary streams to generate a PES stream. Alternatively, each of the PES stream generation sections 3010₁, 3010₂, . . . 3010ₙ, may packetize a single elementary stream to generate a PES stream. An “elementary stream” is a data stream which is individually encoded for each data type such as video data, sound data, illumination control data and the like. For such encoding, for example, an information compression technology by MPEG-2 is used. PES is an acronym of Packetized Elementary Stream. The data structure of the PES stream is the same as the data structure including the at least one PES packet (PES_Packet) shown in FIG. 18.

The multiplexing device 3011 divides n number of PES streams into a plurality of transport packets (Transport Packet) at a transfer unit having a relatively short fixed length of 188 bytes. The multiplexing device 3011 combines these plurality of transport packets by time division multiplexing so as to output a transport stream (Transport Stream).

The error correction section 3012 performs encoding for error correction on the transport stream. This is performed so that even when noise generated when the transport stream is transferred is superimposed on the transport stream, such a transport stream can be corrected into a correct code by the receiving apparatus 3004.

The modulation section 3013 performs prescribed digital modulation processing (for example, QPSK modulation) on an output from the error correction section 3012.

The transmission antenna 3014 transmits an output from the modulation section 3013 to the satellite 3003.

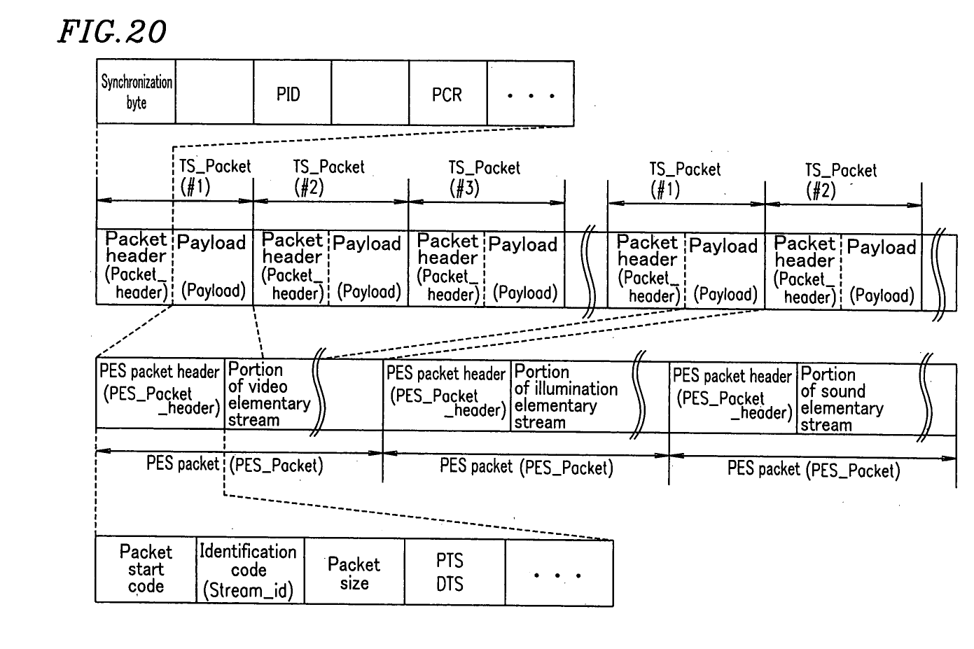

FIG. 20 shows a format of a transport stream conforming to the MPEG-TS system.

In the example shown in FIG. 20, a transport stream defines three programs (program #1, program #2 and program #3). The transport stream shown in FIG. 20 is obtained by dividing three PES streams respectively corresponding to the three programs (program #1, program #2 and program #3) into a plurality of transport packets and combining the plurality of transport packets by time division multiplexing. Each of the three PES streams includes at least one PES packet. Each of the at least one PES packet may be a PES packet including encoded video data, a PES packet including encoded illumination control data, or a PES packet including encoded sound data. (FIG. 20 shows only the PES stream corresponding to program #1 among the three PES stream.)

In the example shown in FIG. 20, the first transport packet (TS_Packet (#1)) is used for transferring at least a portion of the PES packet of program #1. The second transport packet (TS_Packet (#2)) is used for transferring at least a portion of the PES packet of program #2. The third transport packet (TS_Packet (#3)) is used for transferring at least a portion of the PES packet of program #3.

As shown in FIG. 20, the transport stream includes at least one transport packet (TS_Packet).

Each transport packet includes a packet header (Packet_Header) and a payload. The payload has a fixed length of 188 bytes.

In the pack header, a synchronization packet for detecting the start of the transport packet, a packet identifier (PID: Packet Identification) for detecting the start of the transport packet, reference time information (PCR: Program Clock Reference), and the like are described. The PCR is located such that the transmission interval of PCRs is less than or equal to a prescribe time period (for example, 0.1 ms).

In the payload, one of a plurality of portions which are obtained by dividing the PES packet is described. The format of the PES packet is the same as that of the PES packet shown in FIG. 18 and will not be described in detail.

Thus, a transport stream can define a plurality of programs in one stream, and thus is usable for broadcasting. The transport stream is designed with an assumption that the transport stream is used in an environment in which a data transfer error is easily generated, such as broadcasting or a communication network. Accordingly, the redundancy degree of a transport stream is higher than the redundancy degree of a program stream. The transport stream is preferably used in a communication path having a fixed transfer rate. The transport stream is practically used in, for example, SKY PerfecTV, DirecTV, BS digital broadcasting and DTV in the U.S.

The number of programs included in the transport stream, and the relationship of each program with the elements thereof are defined by information referred to as PSI (Program Specific Information). PSI is located in the payload of the transport packet at a unit referred to as “section”. PSI is represented by four tables including PAT (Program Association Table), PMT (Program Map Table). In the PAT, a PID of the PMT corresponding to the program number, for example, is described. In the PMT, a PID of video data, a PID of sound data, a PID of illumination control data, and a PID of a PCR and the like included in the program corresponding to the program number are described.

Returning to FIG. 19, the receiving apparatus 3004 includes a receiving antenna (receiving section) 3016 for receiving an RF signal from the satellite 3003, an LNB (Low Noise Block Converter) 3015 for converting the frequency of the RF signal received by the receiving antenna 3016 so as to convert the RF signal into an IF signal, and an integrated receiver/decoder (hereinafter, referred to as an “IRD”) 3017 for outputting a reproduceable signal in accordance with the IF signal. The IRD 3017 is also called a set top box (STB).

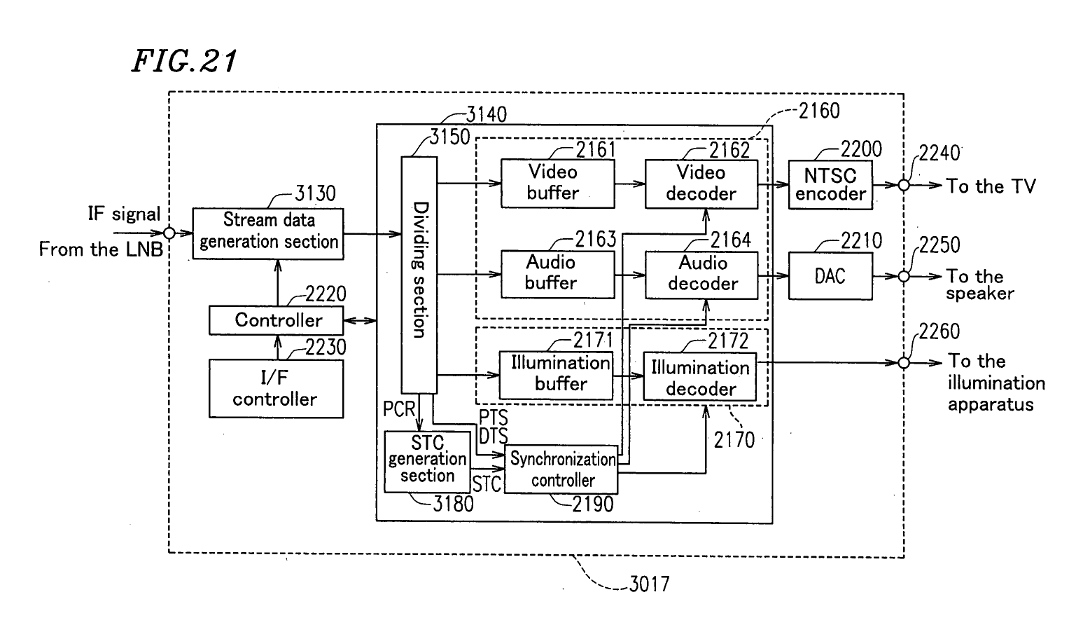

FIG. 21 shows an exemplary structure of the IRD 3017 in the third example. The IRD 3017 outputs a reproduceable signal and thus is also referred to as a reproduction apparatus.

In FIG. 21, identical elements previously discussed with respect to FIG. 14 bear identical reference numerals and the detailed descriptions thereof will be omitted.

A stream data generation section 3130 generates stream data including encoded AV data and encoded illumination, control data, based on the IF signal. As described above, the IF signal is generated based on the output from the receiving antenna (receiving section) 3016. Accordingly, the stream data generation section 3130 acts as a stream data generation section for generating stream data based on the output from the receiving antenna (receiving section) 3016.

The stream data generated by the stream data generation section 3130 has a format conforming to the MPEG-TS system (see FIG. 20). Such stream data is obtained by, for example, performing tuning processing and then performing decoding processing (for example, QPSK modulation) on the IF signal. The structure of the stream data generation section 3130 can be identical with a known structure, and will not be described in detail.

A decoding section 3140 includes a dividing section 3150, an AV data decoding section 2160, an illumination control data decoding section 2170, an STC generation section 3180 and a synchronization controller (control section) 2190.

The dividing section 3150 receives stream data having a format conforming to the MPEG-TS system from the stream data generation section 3130 and divides the stream data into encoded AV data and encoded illumination control data. Such division is performed by referring to the identification code (stream_id) in the PES packet header and the PID in the packet header of the transport packet. By combining two or more transport packets having the same PID, one PES packet is formed. The dividing section 3150 is, for example, a demultiplexer.

The STC generation section 3180 generates an STC (System Time Clock). An STC is obtained by adjusting (i.e., increasing or decreasing) the frequency of a 27 MHz reference clock based on the PCR. An STC is obtained by reproducing reference time which was used when the data was encoded, the reproduction being performed when the encoded data was decoded.

The other elements in the decoding section 3140 are identical with those in the decoding section 2140 shown in FIG. 14. Thus, the synchronization controller 2190 can control the synchronous reproduction of the AV data and the illumination control data in the same method as in the second example.

The decoding section 3140 may include known elements which are not shown in FIG. 21 (for example, an error correction circuit and a descramble circuit).

The transmission apparatus 3002 cannot learn the arrangement of the plurality of pixels 16 in the illumination apparatus 10 which is located at the side of the receiving apparatus 3004. The arrangement of the plurality of pixels 16 can be represented by, for example, one parameter or a combination of two or more parameters. One of such parameters may represent the shape of arrangement (for example, whether the pixels are arranged in a matrix or a delta), may represent the number of pixels (for example, the number of pixels arranged in a horizontal direction, the number of pixels arranged in a vertical direction, etc.), or may represent the model of the illumination apparatus 10. The transmission apparatus 3002 cannot transmit illumination control data which is suitable to the arrangement of the plurality of pixels 16 of the illumination apparatus 10. Therefore, the receiving apparatus 3004 needs to perform some processing.

When, for example, the transmission apparatus 3002 transmits only basic data of the illumination control data (i.e., illumination control data suitable to a representative arrangement of the pixels of the illumination apparatus), the illumination apparatus 10 is structured to process (for example, to thin out or interpolate) the transmitted basic data of the illumination control data, such that the data is suitable to the arrangement of the pixels of the illumination apparatus 10 itself. Alternatively, the basic data may be processed by the IRD 3017. In order to allow the illumination apparatus 10 or the IRD 3017 to appropriately process the basic data of the illumination control data, the illumination apparatus 10 or the IRD 3017 needs to include a comparison section for comparing information indicating which illumination apparatus has a pixel arrangement suitable to the basic data of the illumination control data (pixel arrangement identification information) and information identifying the arrangement of the pixels of the illumination apparatus 10 (identification information), and a processing section for processing the basic data of the illumination control data in accordance with the comparison result of the comparison section. When the pixel arrangement identification information matches the identification information, there is no need to process the basic data of the illumination control data. Accordingly, in this case, the basic data of the illumination control data is controlled not to be input to the processing section, or the processing section is controlled to let the basic data of the illumination control data pass therethrough without processing the data. When the pixel arrangement identification information does not match the identification information, the processing section appropriately processes (for example, thins out or interpolates) the basic data of the illumination control data in accordance with the comparison result. The pixel arrangement identification information is transmitted from the transmission apparatus 3002 to the receiving apparatus 3004 in the state of being, for example, buried in the header of stream data (for example, the packet header (FIG. 20) or the PES packet header (FIG. 20)). Only when the packet data to be transmitted corresponds to a portion of an illumination elementary stream, it is preferable that the pixel arrangement identification information is transmitted from the transmission apparatus 3002 to the receiving apparatus 3004 in the state of being buried immediately after the identification code (stream_id) of the PES packet header. The pixel arrangement identification information can be represented by, for example, a plurality of bits (for example, 4 bits).

When, for example, the transmission apparatus 3002 transmits a plurality of pieces of illumination control data respectively corresponding to a plurality of illumination apparatuses having different pixel arrangements, the illumination apparatus 10 is structured to select illumination control data suitable to its own pixel arrangement, from a plurality of pieces of illumination control data which have been transmitted. Alternatively, such illumination control data may be selected by the IRD 3017. In order to allow the illumination apparatus 10 or the IRD 3017 to appropriately select the illumination control data, the illumination apparatus 10 or the IRD 3017 needs to include a comparison section for comparing information indicating which illumination apparatus has a pixel arrangement suitable to each of the plurality of pieces of illumination control data (pixel arrangement identification information) and information identifying the arrangement of the pixels of the illumination apparatus 10 (identification information), and a selection section for selecting one of the plurality of pieces of illumination control data in accordance with the comparison result of the comparison section. Among the plurality of pieces of illumination control data, the selection section selects the illumination control data corresponding to the pixel arrangement identification information which matches the identification information. How the pixel arrangement identification information is transmitted and represented is as described above.

In order to perform decoding of the illumination control data or other processing without any waste, it is preferable that the illumination control data is selected by the IRD 3017. For example, the stream data generation section 3130 may include the comparison section and the selection section described above. In this case, the controller 2220 controls the stream data generation section 3130, such that the stream data generation section 3130 selects one piece of illumination control data desired by the user, from the plurality of pieces of illumination control data, in accordance with a selection command (command associated with the pixel arrangement identification information) from the user which is input to the I/F controller 2230. Alternatively, when the IRD 3017 already knows the pixel arrangement of the illumination apparatus 10 connected to the IRD 3017, the IRD 3017 may automatically select the illumination control data suitable to that pixel arrangement.

In the second example, the illumination apparatus 10 or the reproduction apparatus 2100 may include the comparison section and the processing section described above. This allows the illumination apparatus 10 or the reproduction apparatus 2100 to appropriately process the basic data of the illumination control data. Alternatively, in the second example, the illumination apparatus 10 or the reproduction apparatus 2100 may include the comparison section and the selection section described above. This allows the illumination apparatus 10 or the reproduction apparatus 2100 to appropriately select the illumination control data.

As described above, according to the third example, a reproduction apparatus capable of reproducing received illumination control data in synchronization with the reproduction of received sound data and/or video data is provided. By connecting the reproduction apparatus to a sound output apparatus (for example, a speaker), a video output apparatus (for example, a TV) and an illumination apparatus, the illumination pattern can be changed in association with the music and/or video provided by broadcasting.

In the third example, the receiving antenna (receiving section) 3016 receives information which is transmitted from the transmission apparatus 3002 in the form of broadcasting. The form of information transmission is not limited to broadcasting. For example, the receiving section may receive information which is transmitted from the transmission apparatus via a network. In this case, the receiving section inputs the received information directly to the decoding section 3140.

### INDUSTRIAL APPLICABILITY

The present invention provides an illumination service of illuminating a prescribed space with a desired form using an illumination apparatus including a plurality of pixels which is independently controllable, and a computer. The computer obtains illumination control data for controlling the plurality of pixels included in the illumination apparatus in accordance with the order for the illumination service. The computer provides the illumination control data. Thus, the space can be illuminated with a form desired by the user, which provides an entertaining factor.

Such an entertaining factor amuses the user. In today's stressful social life, the effect of healing the user's mind is significant.

A reproduction apparatus according to the present invention allows illumination control data recorded on a recording medium to be reproduced in synchronization with the reproduction of sound data and/or video data recorded on the recording medium.

Another reproduction apparatus according to the present invention allows received illumination control data to be reproduced in synchronization with the reproduction of received sound data and/or video data.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. A method for providing an illumination service using an illumination apparatus for illuminating a prescribed space with a desired form and a computer, wherein the illumination apparatus includes a plurality of pixels which are independently controllable, the method comprising the steps of:
the computer receiving an order for an illumination service;
the computer obtaining illumination control data for controlling the plurality of pixels included in the illumination apparatus in accordance with the order for the illumination service; and
the computer providing the illumination control data.

2. A method according to claim 1, wherein the step of the computer providing the illumination control data includes the step of the computer directly transmitting the illumination control data to the illumination apparatus.

3. A method according to claim 1, wherein the illumination service is a service for displaying a message with illumination by the illumination apparatus.

4. A method according to claim 1, wherein the illumination service is a service for displaying an illumination pattern with illumination by the illumination apparatus.

5. An illumination apparatus for illuminating a prescribed space with a desired form, comprising:
a plurality of pixels which are independently controllable;
an interface section for receiving illumination control data for controlling the plurality of pixels from outside the illumination apparatus; and
a control section for controlling the plurality of pixels in accordance with the illumination control data.

6. An illumination apparatus according to claim 5, wherein:
the interface section includes a network communication section connected to a network; and
the network communication section receives the illumination control data via the network.

7. An illumination apparatus according to claim 5, wherein:
the interface section includes a recording medium accessing section for accessing a recording medium; and
the recording medium accessing section reads the illumination control data recorded on the recording medium so as to receive the illumination control data from the recording medium.

8. An illumination apparatus according to claim 5, wherein each of the plurality of pixels includes a light emitting diode (LED).

9. A recording medium having illumination control data, recorded thereon, for controlling a plurality of independently controllable pixels which are included in an illumination apparatus.

10. (Amended) A reproduction apparatus, comprising:
a dividing section for receiving stream data including encoded AV data and encoded illumination control data, and dividing the stream data into the encoded AV data and the encoded illumination control data;
an AV data decoding section for decoding the encoded AV data so as to output AV data; and
an illumination control data decoding section for decoding the encoded illumination control data so as to output illumination control data,
wherein:
the AV data includes at least one of audio data and video data, and the illumination control data is data for controlling a plurality of pixels included in the illumination apparatus, and
the steam data further includes information indicating which illumination apparatus has a pixel arrangement that is suitable to the illumination control data.

11. A reproduction apparatus according to claim 10, further comprising a control section for controlling the AV data decoding section and the illumination control data decoding section,
wherein the control section controls the AV data decoding section and the illumination control data decoding section, such that a timing of the decoding or the output performed by the AV data decoding section and a timing of the decoding or the output performed by the illumination control data decoding section are synchronized with each other.

12. A reproduction apparatus according to claim 10, further comprising:
a read section for reading information recorded on a recording medium; and
a stream data generation section for generating the stream data based on an output from the read section.

13. A reproduction apparatus according to claim 10, further comprising:
a receiving section for receiving information transmitted from a transmission apparatus; and
a stream data generation section for generating the stream data based on an output from the receiving section.

14. A reproduction apparatus according to claim 13, wherein the receiving section receives the information which is transmitted from the transmission apparatus in the form of broadcasting.

15. A reproduction apparatus according to claim 13, wherein the receiving section receives the information which is transmitted from the transmission apparatus via a network.

16. (Deleted)

17. (Added) A method according to claim 3, wherein in the step of receiving the order for the illumination service, time and day at which the illumination service is to be provided is indicated.
